(19) United States
(12) Patent Application Publication
(10) Pub. No.: US 2001/0051881 A1
(43) Pub. Date: Dec. 13, 2001

(54) System, method and article of manufacture for managing a medical services network

(75) Inventor: Aaron G. Filler, Santa Monica, CA (US)

Correspondence Address: BAKER & MCKENZIE, 2300 TRAMMELL CROW CENTER, 2001 ROSS AVENUE, DALLAS, TX, 75201, US

(73) Assignee: Aaron G. FILLER

(21) Appl. No.: 09/746,429

(22) Filed: Dec. 22, 2000

Related U.S. Application Data
(60) Provisional application No. 60/171,446, filed on Dec. 22, 1999.

(51) Int. Cl. G06F 17/60

(52) U.S. Cl. 705/3

(57) ABSTRACT

A system, method and article of manufacture are provided for managing a medical services network in accordance with an embodiment of the present invention. Diagnostic data about a patient is received from a diagnostic service source. This diagnostic data is obtained by the performance of a diagnostic service on the patient by the diagnostic service source. The diagnostic data is then sent to an interpreter who interprets the processed diagnostic data to generate an interpretation of the diagnostic data. The interpretation is received from the interpreter. Subsequently, the interpretation and/or the diagnostic data may be transmitted to a display via a network. The security of the patient records are optionally protected through password protection and public key encryption in accordance with the Health Information Portability and Accountability Act (“H.I.P.A.”)

### CROSS REFERENCE TO RELATED APPLICATIONS

This application claims priority under 35 U.S.C. §119(e) to U.S. Provisional Application Ser. No. 60/171,446, filed Dec. 22, 1999, the contents of which are incorporated herein by reference.

### FIELD OF THE INVENTION

The present invention relates generally to medical diagnostic systems and, more particularly, network-based distributed medical diagnostic systems.

### BACKGROUND OF THE INVENTION

Many medical records are maintained on an entirely local basis. However, often times, medical information about a patient must be shared amongst various health care and diagnostic services providers who are often located at remote locations from one to another. When a health care provider refers a patient for treatment, tests or consultation, the health care provider, hospital, clinic or laboratory typically creates and updates files for the patient. These files may also include the patient's billing, payment and scheduling records. As a result, the patient files at one health care provider may have different information than patient files at another health care provider. In such an environment, specific patient data may be difficult to access when needed for analysis. The creation of patient data in remote locations exacerbates this problem. In addition, the wide variety of data formats for patient data hinders electronic processing and maintenance of patient files. Moreover, the use of a patient's file by one healthcare provider may preclude its simultaneous use by another healthcare provider.

### DESCRIPTION OF THE INVENTION

A system, method and article of manufacture are provided for managing a medical services network in accordance with an embodiment of the present invention. Diagnostic data about a patient is received from a diagnostic service source. This diagnostic data is obtained by the performance of a diagnostic service on the patient by the diagnostic service source. The diagnostic data is then sent to a reading physician, who is the interpreter that interprets the processed diagnostic data to generate an interpretation of the diagnostic data. The interpretation is received from the reading physician or interpreting physician. Subsequently, the interpretation and/or the diagnostic data may be transmitted to a display via a network.

### BRIEF DESCRIPTION OF THE DRAWINGS

The foregoing and other features, and aspects are better understood from the following detailed description, appended claims, and accompanying drawings where:

FIG. 1 is a flowchart for a process for managing a medical services network in accordance with an embodiment of the present invention;

FIG. 2 is a schematic diagram illustrating interactions with patients and physicians in a medical services network in accordance with an embodiment of the present invention;

FIG. 3 is a schematic diagram illustrating image interpretation assembly in a medical services network in accordance with an embodiment of the present invention;

FIG. 4 is a schematic diagram of an exemplary operation workflow for managing a medical services network in accordance with an embodiment of the present invention;

FIG. 5 is a schematic diagram illustrating an exemplary data center organization in a medical services network in accordance with an embodiment of the present invention;

FIG. 6 is a schematic diagram illustrating administrative operations that may be carried out in a medical services network in accordance with an embodiment of the present invention;

FIG. 7 is a schematic diagram of an illustrative system with a plurality of components in accordance with an embodiment of the present invention;

FIG. 8 is a schematic diagram of a representative hardware environment in accordance with an embodiment of the present invention;

FIGS. 9-19 are screen images of a preferred user interface for composing and reviewing live medical records; and

FIG. 20 is a block diagram illustrating the work flow of live medical records over a networked physician web site system.

### MODES FOR CARRYING OUT THE INVENTION

In general, the structure of the medical service network is as follows. Enrolled referring physicians have secure access to the physician web site system via a public key encryption system using Virtual Private Network (VPN) software or hardware or SSL-class security. The patient records are optionally protected throughout the system using password access and public key encryption, preferably in accordance with the Health Information Portability and Accountability Act (“H.I.P.A.”).

The physician is able to refer a patient felt to be in need of the particular diagnostic or medical service, by example MR Neurography via the physician web network. The referral may take the form of an electronically transmitted and electronically signed order or prescription. The managing medical entity (MME) then assigns the patient to a contracted imaging center, contacts the patient and instructs them on contacting the imaging center. The physicians employed or contracted by the MME generate an image prescription for the test to be carried out at the imaging center (IC) and inform the IC that the patient will contact them for scheduling. Time on the imaging equipment at the imaging center may be purchased, leased by time, or paid on a test by test basis.

The assembly of data by the MME may include the use of RIS (radiology information system) software optionally compatible with the HL/7 standard. All RIS information, billing information, scheduling information, scans of paper documents such as insurance cards, consents, arbitration agreements, assignment of benefits, patient history, or other forms are optionally included together with the image data in a patient electronic folder. Alternately, the various classes of data are stored in separate database files, but in all cases linked together using methods such as the standard relational database structure.

When passing the patient medical records through the system, hardware and software within the system optionally logs the patient record transmission and reception by the various system users. This essentially provides an electronic paper trail for the patients' medical records.

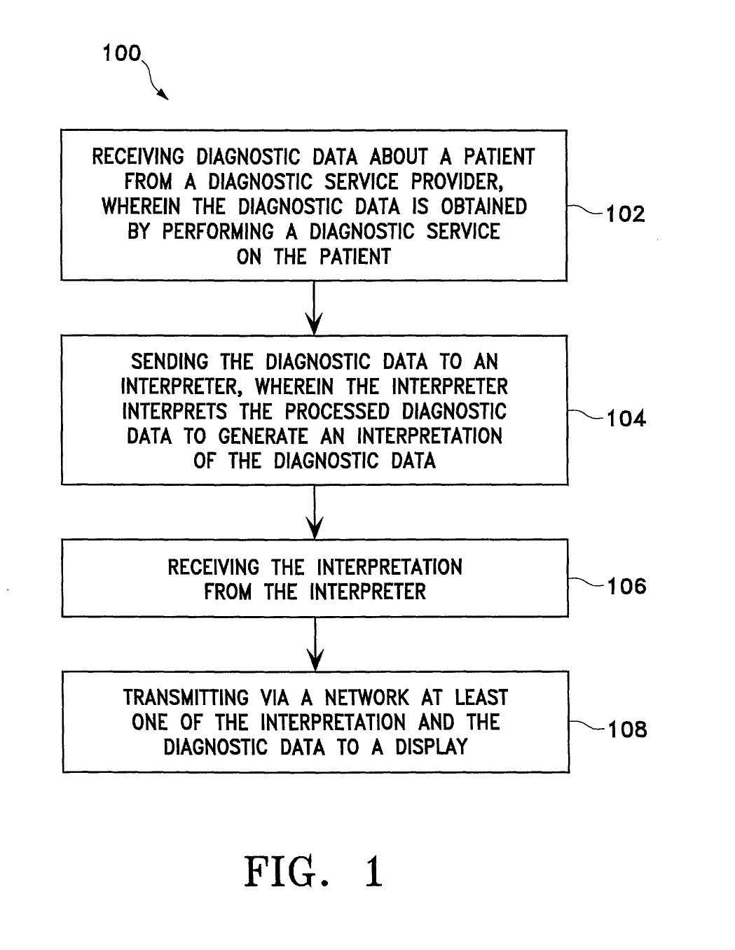

FIG. 1 is a flowchart for a process 100 for managing a medical services network in accordance with an embodiment of the present invention. In operation 102, diagnostic data about a patient is received from a diagnostic service source. This diagnostic data is obtained by the performance of a diagnostic service on the patient by the diagnostic service source. The diagnostic data is then sent to an archiving and diagnostic data processing center for optional three dimensional image analysis in the case of images. Finally, the raw images in addition to the post-processed images are sent to a reader or reading physician in operation 104 who interprets the processed diagnostic data to generate an interpretation of the diagnostic data. In operation 106, the interpretation is received from the reader. Subsequently, the interpretation and/or the diagnostic data is archived. Then authorized users such as the referring physician and the patient may, through password access be able to view the diagnostic data and interpretation through a display via a network in operation 108 or receive the information on paper or on compact disk or other comparable distribution format.

In one embodiment of the present invention, the diagnostic data and the interpretation may be stored in a database. In another embodiment, billing codes and related documentation may also be generated and then transmitted to an insurer. In an aspect of the present invention, the network may be utilized to receive the diagnostic data from the diagnostic service source, to send the diagnostic data to the data processing center and then on to the reading physician as well as to receive the interpretation from the reader. In one embodiment, translation services could be provided at the data processing center whereby textual data in a live medical record can be translated to different languages for reading physicians in different countries.

In one aspect, the network may capable of communication utilizing TCP/IP and IPX protocols. An illustrative example of such a network is the Internet. Data transport across the Internet may be optionally carried out via Virtual Private Network encryption, or encryption via wavelet compression or other comparable technique. In another aspect, the diagnostic service performed on the patient may involve magnetic resonance imaging (MRI) (such as, for example, MR Neurography) so that the diagnostic data comprises imaging data obtained from the magnetic resonance imaging of the patient.

Diagnostic service should be broadly construed to include other types of patient imaging, such as electrocardiograms (EKG) and other similar non-text data which are not specifically diagnostic images. Further, diagnostic images can include MRI, CT scans, digitized X-rays, motion fluoroscopy, angiograms, ultrasound, and nuclear medicine images. Still other types of images which may be broadly included within diagnostic data include pathology slides, electroencephalograms (EEG), intensive care unit monitoring data, and even scanned medical record information in hand-written form such as medication prescriptions, doctor's notes, drawings, retinal photographs, plastic surgery photographs (cosmetic, bum, reconstructive), orthopedic implant images, surgical procedure drawings which show how a device is implanted or a surgery is carried out, heart sounds and their graphical representation, and various other similar images, whether those images represent portions of a patient's anatomy or graphically represent some other aspect of a patient's condition.

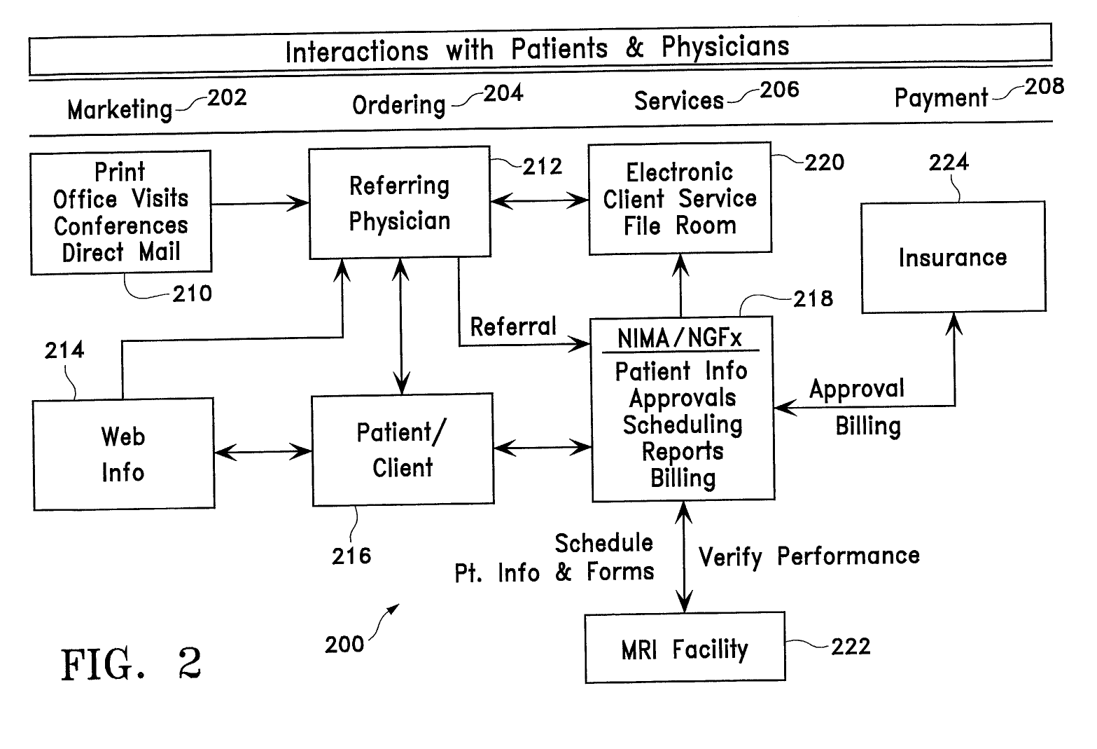

FIG. 2 is a schematic diagram illustrating interactions with patients and physicians in an medical services network 200 in accordance with an embodiment of the present invention. Generally, there may be four categories of interactions including: marketing interactions 202, ordering interactions 204, services interactions 206, and payment interactions 208. Marketing interactions 202 may include various types of advertising 210 including print advertisements, office visits, conferences, and direct mail directed to health care providers 212 as well as advertisements and information 214 available to both health care providers and patients 216 via the Internet and World Wide Web. As illustrated in FIG. 2, the ordering interactions of the medical services network may involve various interactions with health care providers 212 as well as patients 216. The serving interactions 206 may include interactions involving a managing medical entity 218 as wells as electronic client service file room interactions 220 and interactions with a diagnostic service source 222 such as a MRI facility. Payment interactions 208 may involve interactions with an insurance provider/insurer 224.

In one embodiment of the present invention, scheduling performance of a diagnostic service in the medical services network may also be facilitated. In such an embodiment, a request for a diagnostic service for a patient is received from a health care provider (such as a physician) utilizing the network. The patient is then assigned to a source of the diagnostic service (i.e., a diagnostic service source). The diagnostic service source is then notified of the patient assignment utilizing the network and the patient is instructed to contact the diagnostic service source to schedule an appointment for performing the diagnostic service. In another embodiment, the patient may be enabled to contact the diagnostic service source via the network in order to schedule the appointment for performing the diagnostic service. In a further embodiment, the network may also be utilized to direct advertising information such as information about the diagnostic service to the health care provider and/or the patient.

In even another embodiment of the present invention, an insurer of the patient may also be notified about the diagnostic service utilizing the network to facilitate payment of the various services by the insurance provider. In yet another embodiment, information relating to the patient assignment may also be in the database. As a further option, the health care provider, the patient, and/or the diagnostic service source may be permitted to access the information stored in the database utilizing the network. As another option, additional information relating to the patient (e.g., name, address, employer, insurance provider, medical conditions, reasons for requesting the diagnostic service, etc.) either from the patient and/or the health care provider) may also be obtained utilizing the network subsequent receipt of the request for the diagnostic service, and storing the obtained information relating to the patient in a database.

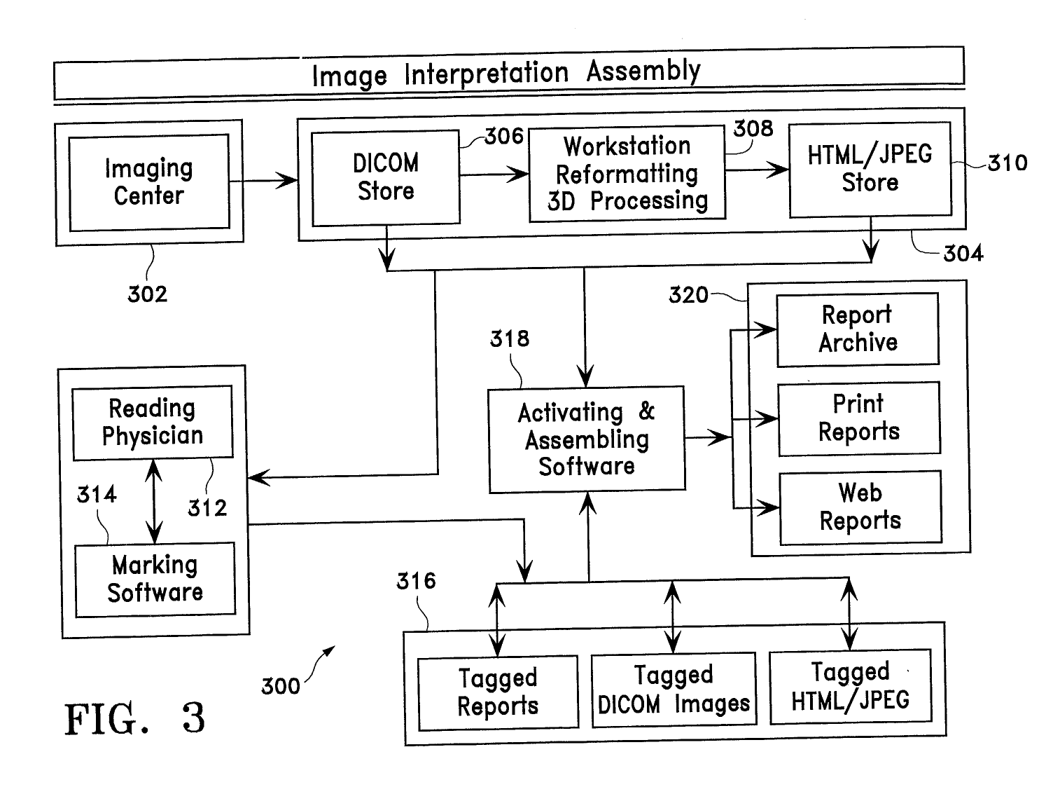

FIG. 3 is a schematic diagram illustrating image interpretation assembly 300 in a medical services network in accordance with an embodiment of the present invention. In general, image interpretation assembly is carried out first by forwarding imaging data from a imaging center 302 to a data processing center 304 of the MME. In the data processing center 304 the raw imaging data may be stored in a first data store 306 such as a DICOM store as well as subject to processing for 3D reformatting 308 so that a reformatted version of the imaging data by be stored in a second data store 310 (such as a HTML/JPEG store).

An reading physician 3012 may then receive the imaging data from both the first and second stores 306, 310. The reading physician may also have marking software 314 for annotating the data during the generation of the interpretation of the imaging data. The interpretation is then sent to a database 316 of the MME for organized storage. An activating and assembly component 318 may then be utilized to retrieve information from the first and second data stores 306, 310 as well as from the central database 316 to generate reports 320 which can be stored in a report archive, printed, and/or displayed via the Internet as shown in FIG. 3.

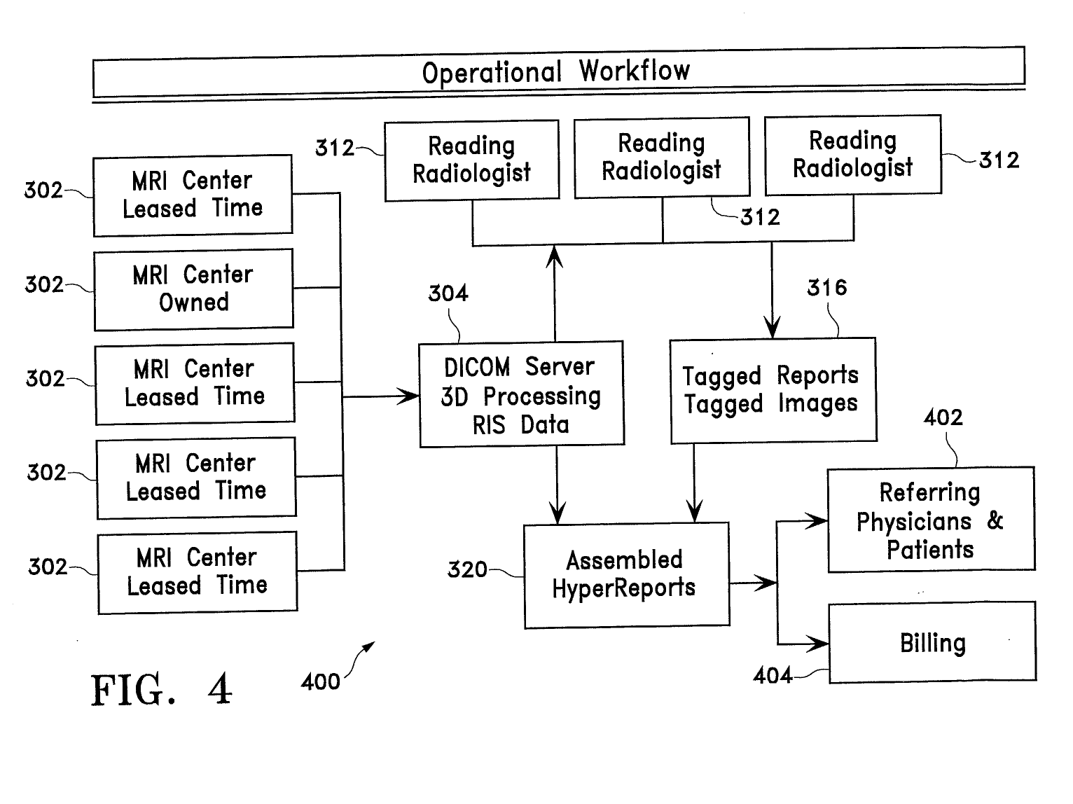

FIG. 4 is a schematic diagram of an exemplary operation workflow 400 for managing a medical services network in accordance with an embodiment of the present invention. Diagnostic data about patients is forwarded from one or more diagnostic service sources 302 (such as MRI sources) to the data processing center of the MME. The diagnostic data is then sent to one or more reading physicians (for example reading radiologists) for interpreting the diagnostic data in order generate interpretations of the diagnostic data. These interpretations may then be sent back to the MME where they may be further processed and then stored in a database 316. Reports may then be assembled from the stored information and sent via a network to physicians and/or patients 402 for viewing. Billing information may also be generated 404.

In closer detail, the patient contacts the IC or the IC contacts the patient either by phone or through a web based scheduling system provided by the MME to schedule the patient for a diagnostic test. The diagnostic test or MRI scan is carried out at the IC and the raw data from the MRI is delivered to a server, optionally a systemless server attached to the MRI console by Ethernet cable or alternately by first recording the data on an optical disk, DAT tape or other appropriate media then moving the media to a reader attached to the server. Typically, the server will provide DICOM storage server functionality or comparable functionality for receiving image data from the diagnostic equipment. The server may be optionally instructed to copy the data to a second server which maintains a mirror image of all data. Then, either using an internal program or on a ‘pull’ basis, the MME's Data Processing Center (DPC) causes the server to transmit the data from either through a leased line, a dial up line, or through the internet using VPN protocols and encrypted in any case including by example 128 bit encryption or 168 bit triple DES encryption.

It should be noted that diagnostic data may be DICOM file format or in any other suitable file format. Security may also be obtained through a variety of compression algorithms such as wavelet compression and other similar technologies if it is preferred that compressed images be transferred and that VPN encryption be avoided. This approach is most appropriate for providing images to patients and in come cases to referring physicians and is less optimal for providing images for primary reading by the radiologist or other physician. It should also be noted that the interpretation and/or the diagnostic data may also be encrypted prior to transmission to the display.

In all cases, the system may be designed and optimized to provide a very high level of confidentiality and security to protect the patients control of access to their own medical information. Further at all stages of information transfer, backups may be generated before and after transfer, and the transmission and receipt and verification of quality of all information may be logged so that all such transfers may be tracked actively and from archives. At all stages of the data collection, interpretation, storage and distribution process, appropriate billing codes and billing documentation are generated. Provision may also be included for secure authentication of all physicians who provide interpretations or manipulate the data. Access rights to the data by patient, referring physician, treating or interpreting physician, additional physician designated by the referring physician or patient, or appropriately authorized third party are also tracked and associated with the data during transmission, storage, and distribution.

Data may be moved through a DICOM query/retrieve system or the data may be moved as simple file transfers without recourse to DICOM transfer protocols. The avoidance of DICOM file transfers and the substitution of other secure and accurate transfer methods may help to yield a very large increase in the speed of data transmission.

In addition to the image data, the system allows for real-time images from a web camera or similar devices to be stored with the patient record. The web cam may be used by the physician or senior technician at the central location to monitor and support the performance of the tests at the distributed image sites. Thus, in an embodiment of the present invention, the diagnostic data may also include video data captured by a video camera located at the diagnostic service source during performance of the diagnostic service on the patient. In an embodiment of the present invention, the network may also be to provide real-time monitoring and support to the diagnostic service source relating to performance of the diagnostic service before, during and after performance of the diagnostic service on the patient. In such an embodiment, the video camera located at the diagnostic service source may be utilized to help provide the monitoring and support.

Optionally, the IC sites are provided with two different means of connection such as DSL or Ti connecting though the internet and as a backup, ISDN which can connect either through the internet or directly to an ISDN modem at the MME.

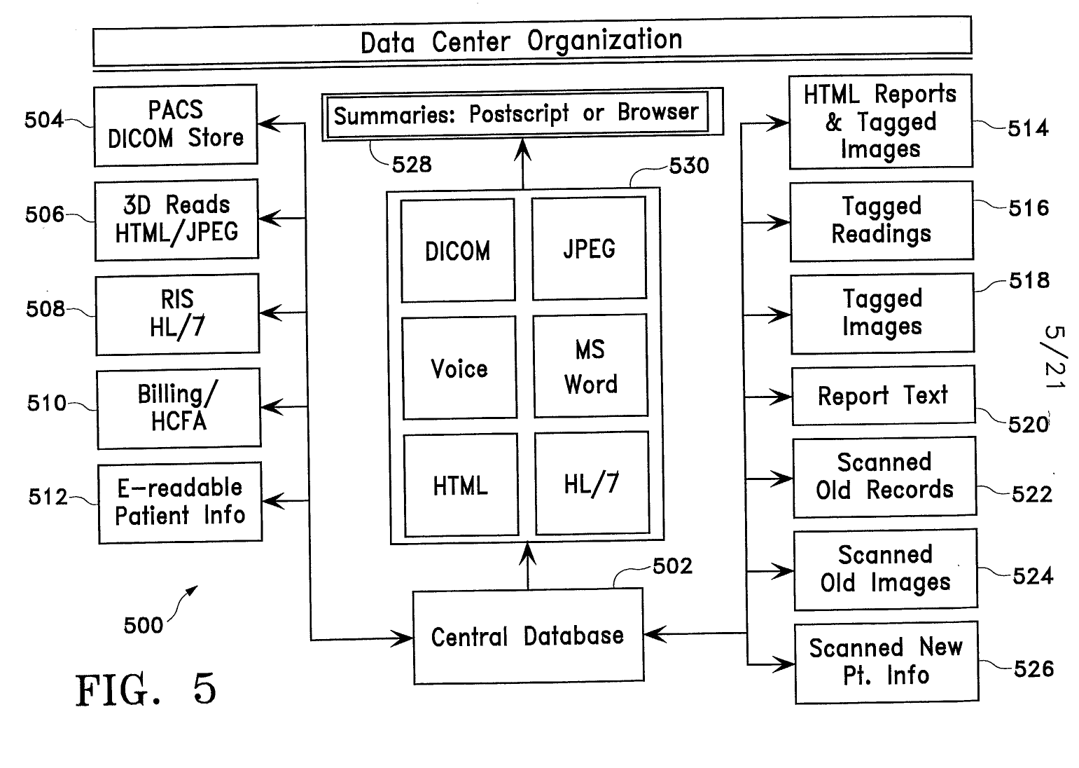

In a further embodiment of the present invention, the diagnostic data may be processed prior to sending the diagnostic data to the reading physician (see FIG. 3 elements 306, 308, and 310). Such processing may include performing file conversions, image reconstitutions, as well as post-processing analysis on the diagnostic data. In particular, at the DPC, any necessary file conversions or image reconstitutions are carried out and the image data may then be subjected to any necessary post-processing analysis such as 3D projections, image intensity corrections and reconstructions as are needed to complete the image process. In addition, various images or reconstructions may be colorized to better demonstrate various shades of gray and simplify comparisons of intensity among various regions of the image. The raw image data together with the reconstructions are then stored and archived at mirrored on-site and off site locations (see FIG. 5). The DICOM or other format images may be recoded as JPEG or other web-suitable format (GIF, BMP) and embedded in HTML, XML or other comparable pages or other browser readable pages. Besides the technical transformations described above, it may also be desirable to have the textual data in the patient records translated (e.g., English-to-French, German-to-Spanish) at the data processing center or at another center for the benefit of physicians from different countries.

In an additional aspect of the present invention, the interpretation may include: a diagnosis based on the diagnostic data, annotations, and/or selectable links to additional information relating the diagnostic data. In particular, the complete file of image data and post-processed images may be transmitted through a separate network to distribute the data to an employed or contracted reading physician with appropriate credentials who carries out a radiological image interpretation (see e.g., FIGS. 3 and 4, element 312). They may also be copied on CD ROM, or DVD RAM, or Zip disk or other format for storage or physical transfer. The reader then transmits the interpretation or reading back to the DPC. The reading may be done by dictation for transcription, but in any case a transmissible, readable file containing the image interpretation or other diagnostic interpretation (such as an EMG reading or EEG or EKG reading) is ultimately received by the DPC (see e.g., FIGS. 3 and 4, element 316). The reader may use any one of a variety of types of workstation software or may use an applet based, java type image workstation software delivered via the web. This software may also provide the reader with the capability to carry out additional reconstructions and 3D manipulations which can then be returned to the DPC for archival storage and distribution. In addition to returning a reading, the reader may also make various notations on the most informative images such as placing colored arrows pointing to key findings and correlated by number with items in the radiology report. Software is provided to help the radiologist label the findings in the image and correlate these with information in the report.

In addition, software (see e.g., FIG. 3, element 314) may be provided to the reader and may also available at the DPC so that features identified by the reading radiologist may guide the placement of HTML (or XML) buttons, anchors, links or other HTML or other web readable marks. In this fashion, a lay person or physician viewing the image may point to the image feature with a mouse or other pointing system or keystroke method and the image or other diagnostic feature will be linked to the appropriate text in the interpretation as well as to appropriate anatomical, medical, physiological or prognostic information.

In this fashion, an observer who “clicks” on a marked feature in the image can learn what the structure is and also learn why the radiologist has chosen to highlight or point out the feature, and also learn the diagnostic, therapeutic, or prognostic implications of the anatomical feature or abnormality. Optionally, information about various types of appropriate therapy may be linked to the report including physical therapy, medications, and various types of surgical procedure. For authorized third party payor viewers, there may be links to published outcome study data and medical care algorithms. For specialist surgical viewers, there may be links to published articles on methodology and outcomes of new medical or surgical treatment methods or devices. Similar considerations apply for X-rays, CT scans, angiograms, ultrasounds, echocardiograms, nuclear medicine studies, electrophysiologic studies such as electromyography, electroencephalography, or electrocardiography or any type of MRI scanning, lab test, genetic data, or any other non-text medical data.

Conversely, key anatomic, diagnostic, and descriptive words in the text are automatically linked to appropriate database information sources by a program which scans the text for linkable words and then activates the links. In addition the reading physician or assisting technician at the DPC may link these words in the text to appropriate features in the image by use of anchors, button fields, or other similar activating features in HTML or other browser readable languages or other machine readable languages.

The DICOM images can be converted to JPEG or other web transportable formats and may be included in the report or presented as separate data. The referring physician or patient may view the reports and images with viewing software on a CD-ROM or downloaded to the their browser using a format such as a JAVA applet design.

These considerations are meant to apply to dynamic features as well such as series of images which record motions across a joint or moving pointers which track a structure across an image plane or among a series of planes and also which follow a single feature as it appears in a series of images from a series of image planes which are paged rapidly or slowly in sequence and this similarly applies to three dimensional reconstructions which are made from the original data to assist the viewer in navigating the three dimensional image space associated with the object such as the nerve image.

At the DPC, novel software scans the report for all medical words and phrases so that these may be converted from text words to links to one of several information databases. The final report with images, marked images, and links form the text and from the image is then made available to the referring physician via the physician network. The report and images can also be accessed by the patient using a separate password network. The final data set is stored and archived and is additionally made available in printed film, printed paper, CD-ROM or DVD or other useful format as hard copy.

In one aspect of the present invention, the transmitting via the network of the interpretation and/or the diagnostic data to the display may be carried out upon receiving a request for the interpretation and/or the diagnostic data from a viewer utilizing the network. The viewer may then be required to select a reading category with each reading category having a set of links to additional information associated therewith. The interpretation and/or diagnostic data with the links associated with the selected reading category may then be displayed to the viewer via the network. In closer detail, the individual reading the report selects their reading category from a set of reading categories including: a) patient with high school education; b) patient with college education; c) patient with advanced non-medical education; d) patient who is non-physician health professional; e) physician generalist e.g. internist, family practice, emergency medicine, pediatrician, gynecologist; f) physician general surgeon; g) physician neurologist; h) physician neurosurgical specialist; i) radiologist; and j) neuroradiologist k) authorized third party payor, 1) student with access to medical data stripped of patient identifying information or other useful category of viewer. Based on the category selection, the links in the report are then channeled to appropriate web based medical information pages. For example, category “a” link selections may provide very basic explanations of terms in simple lay language, category “e” may provide sufficient information for the family practitioner to explain the findings to the patient to make appropriate referrals. Category “h” links may provide various optional surgical techniques relevant to the diagnosis with related recent academic references and associated index medicus on-line links.

FIG. 5 is a schematic diagram illustrating an exemplary data center organization 500 in a medical services network in accordance with an embodiment of the present invention. As illustrated in FIG. 5, a central database 502 may be utilized to store various types and kinds of information including a PACS (Picture Archiving and Communication System) DICOM Store 504, 3D Reads in HTML and JPEG formats 506, RIS HL7 information 508, billing and HCFA information 510, e-readable patient information 512, HTML reports and tagged information 514, tagged readings 516, tagged images 518, report text 520, scanned old records 522, scanned old images 524, and scanned new patient information 526. A report generated 528 in the medical services network may then access on pertinent data 530 (in a variety of formats) stored in the database associated with the report via the links included in the report.

The central database 502 for the system generates query and report pages 528 which have fields capable of holding various types of data. The data may be HL/7 protocol RIS data, HCFA oriented billing data, JPEG or TIFF images, DICOM format images with all DICOM header info readable, PDF or postscript conversions, voice for reports dictated but not yet transcribed (wet reads), HTML/XML or other dynamic markup languages, video in e.g. Quick Time or other analogous format, text in the form of MS Word documents or similar word processed documents from other analogous formats (see 530). By allowing the mixing of data from various image sources, various text sources, various types of scanned in images, and various database and text structures, this system allows for the integration of widely varied types of data each stored in traditional industry standard formats but pulled together into the database page. The user may then see output on screen, via their browser or printed so that the different internal structures of the data will not affect the ability of the user to view all the associated data for a patient together in one location with both static and dynamic links among the data elements.

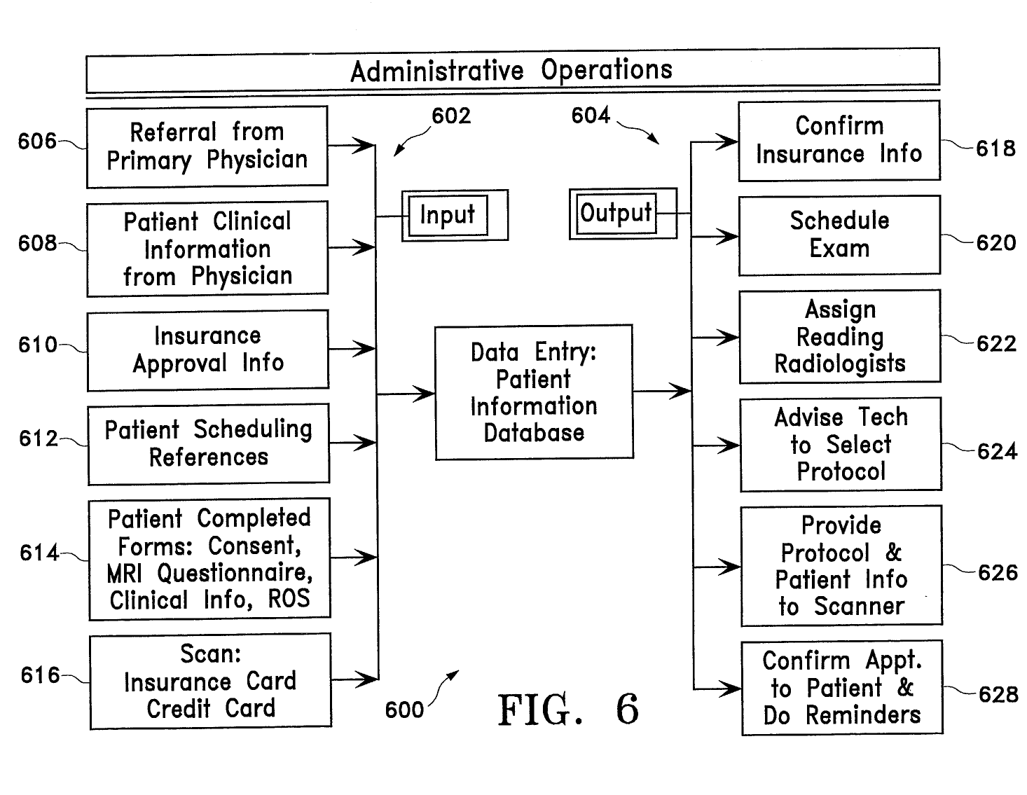

FIG. 6 is a schematic diagram illustrating administrative operations 600 that may be carried out in a medical services network in accordance with an embodiment of the present invention. In general, the administrative operations may be divided into information inputted 602 into the system and information that is output (i.e., generated) based on the input information. Examples of input information 602 include referral information 606, clinical information about the patient 608, insurance information 610, scheduling preferences of the patient 612, information obtained from forms completed by the patient 614, and information obtained from scanning various cards of the patient 616. Examples of output information 604 generated by the medical services network based on the input information includes information to be provided to an insurer 618, scheduling information 620, information about reading physician's assignment 622, advisory information 624, protocol and patient information 626, and confirmation information 628.

MR Neurography is the result of research into methods of optimizing the details of MRI scanning so that the nerves become the brightest objects in the image. This allows for three dimensional reconstruction of the image of the nerves. There are no contrast agents or injections involved. The test may typically take about 30 to 40 minutes. MR Neurography is a means of optimizing an MRI scan for sensitivity to special biophysical properties of nerve. Many of technical details of MR Neurography are explained in U.S. Pat. No. 5,560,360 to Filler et al. entitled, “Image Neurography and Diffusion Anisotropy Imaging” and U.S. Pat. No. 5,706,813 to Filler et al. entitled, “Focal Neurographic Magnetic Resonance Imaging System” which are both incorporated herein by reference.

In MRI scanning, the scanner is able to detect subtle differences in the behavior of protons and these are most abundant in water. Water in different tissues may have different appearances in the image because of effects of material dissolved in the water which affect the tumbling rate of the water molecules, it may also be affected by magnetic properties of materials dissolved in or near the water.

Also, the way in which water molecules move or diffuse in tissues can affect their appearance. There are also protons in different forms and the second most abundant are those participating in fat or lipid molecules. In MRI scanning, it is possible to use radio frequency pulses and magnetic field shifts to accentuate the appearance of one type of proton over the appearance of another. In addition to the fine aspects of the collection of the image, there are a variety of specialized computer processing steps required to complete the process of presenting a detailed image of the nerve for review. The final image is then interpreted by a specially trained and credentialed neuroradiologist. These doctors have special experience in reviewing and analyzing nerve images.

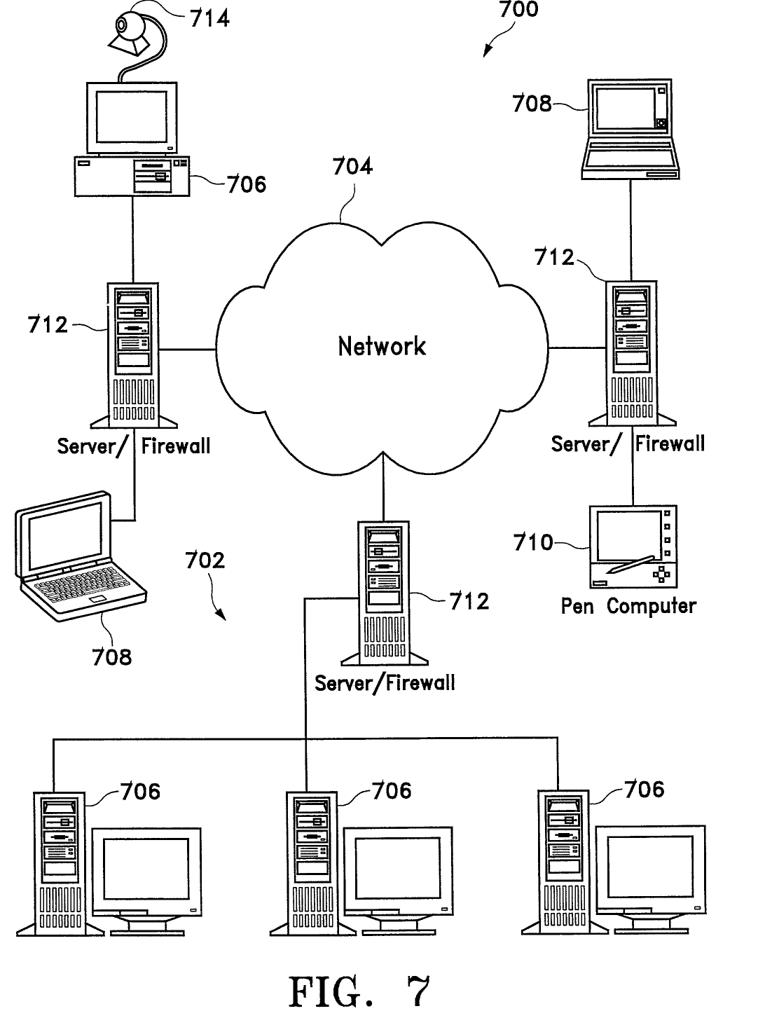

FIG. 7 illustrates an exemplary system 700 with a plurality of components 702 in accordance with an embodiment of the present invention. As shown, such components include a network 704 which take any form including, but not limited to a local area network, a wide area network such as the Internet, etc. Coupled to the network 704 is a plurality of computers which may take the form of desktop computers 706, laptop computers 708, hand-held computers 710, or any other type of computing hardware/software. As an option, the various computers may be connected to the network 704 by way of a server 712 which may be equipped with a firewall for security purposes. As a further option, a video camera 714 may be coupled to a computer to permit the capture of video images with the video camera and transmission of the captured video images from the computer to other computers via the network. It should be noted that any other type of hardware or software may be included in the system and be considered a component thereof.

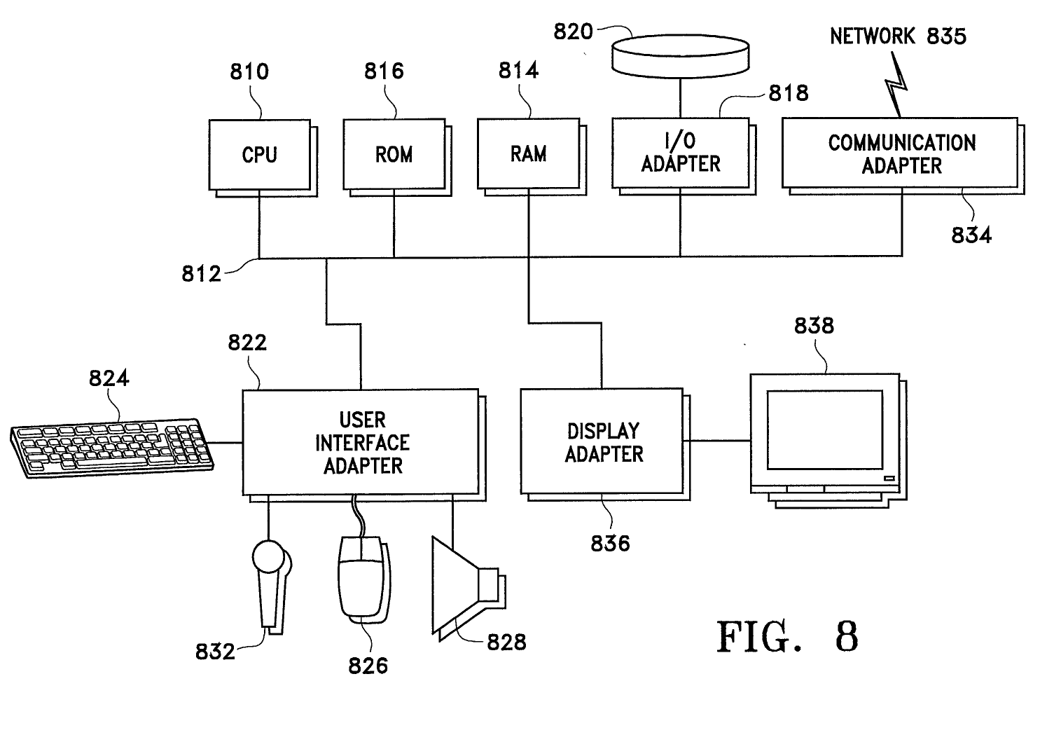

A representative hardware environment associated with the various components of FIG. 7 is depicted in FIG. 8. In the present description, the various sub-components of each of the components may also be considered components of the system. For example, particular software modules executed on any component of the system may also be considered components of the system.

FIG. 8 illustrates a representative hardware environment 800 by which embodiments of the present invention may be carried out. In the present description, the various sub-components of each of the components may also be considered components of the system. For example, particular software modules executed on any component of the system may also be considered components of the system. The hardware configuration 800 illustrated in FIG. 8 includes a central processing unit 802, such as a microprocessor, and a number of other units interconnected via a system bus 804.

The workstation 800 shown in FIG. 8 includes a Random Access Memory (RAM) 806, Read Only Memory (ROM) 808, an I/O adapter 810 for connecting peripheral devices such as disk storage units 812 to the bus 804, a user interface adapter 814 for connecting a keyboard 816, a mouse 818, a speaker 820, a microphone 822, and/or other user interface devices such as a touch screen (not shown) to the bus 804, communication adapter 824 for connecting the workstation to a communication network 826 (e.g., a data processing network) and a display adapter 828 for connecting the bus 804 to a display device 830.

The workstation typically has resident thereon an operating system such as, for example: the Microsoft Windows NT or Windows95/98/2000 Operating System (OS), the IBM OS/2 operating system, the MAC OS, or UNIX operating system. Those skilled in the art will appreciate that the present invention may also be implemented on platforms and operating systems other than those mentioned. For example, the workstation could alternatively be a graphical terminal connected to a mainframe, mini-, or super-computer.

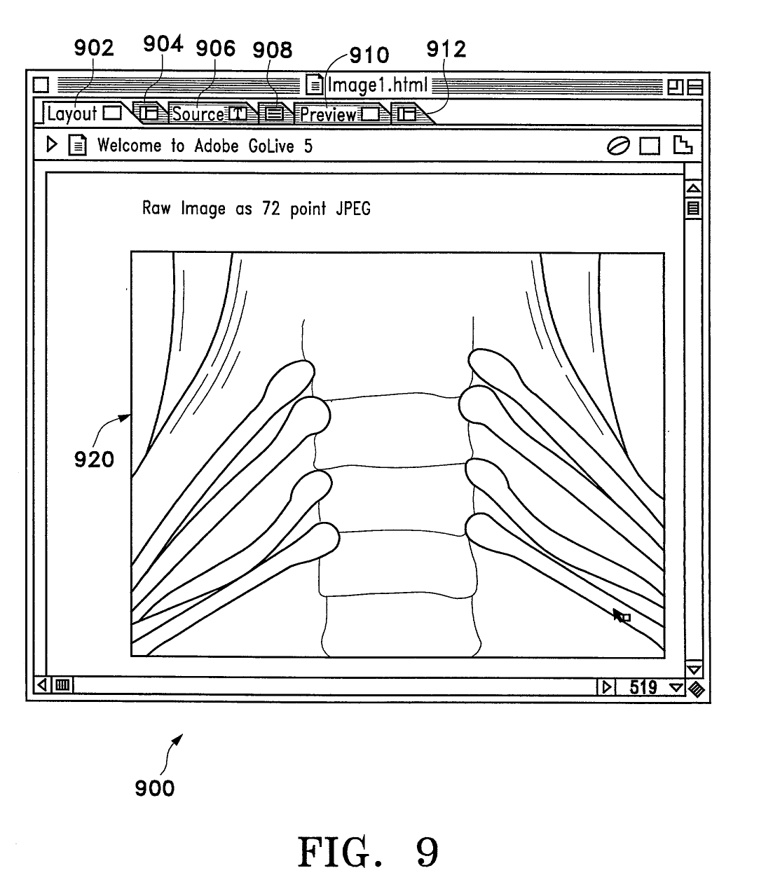

FIGS. 9-19 are screen images of a preferred user interface for composing and reviewing live medical records on a workstation such as described in FIG. 8. Preferably, the user interface will be a web-enabled interface, such that the composition and review of the live medical records can be conducted independently of the physical location of those records; thus, such records may be referred to as “web medical records. This is the first in a series of screen shots which demonstrate some of the fundamental methodology underlying the web medical record. Selected images are loaded, optionally as JPEG files into an HTML “jacket” which renders them accessible and manipulable through a web browser and by use of HTML (hypertext mark up language), XML, Dynamic HTML or other similar computer programming languages. These are also susceptible to interaction with “CGI” software which resides in the host server computer and interacts with the individual who is viewing the pages through their browser.

FIG. 9 shows a screen image 900 for the preferred user interface configured in its “Layout” mode. It can be seen that the interface is in the layout mode by the lighter shading of the “Layout” tab 902 at the top of the screen. Other available tabs shown here are a first image combination tab 904, a “Source” tab 906, a text tab 908, a “Preview” tab 910, and a second image combination tab 912. These tabs 902-912 are used to toggle between different views and modes of the live medical record. In the Layout mode, preferably a software module is provided for image manipulation and annotating. For example in the screen image 900, a “raw” 72 point JPEG file is provided showing a patient image 920. This “raw” patient image 920 initially does not have associated with it any links or annotations. Software programs that can be used to annotate and overlay hyperlinks over this raw patient image 920 include software packages such as Adobe Photoshop TM, Microsoft Word TM, or Adobe GoLive TM. Alternatively, another proprietary software package could be developed to specifically handle this task. Although the raw patient image 920 above has been shown as a two-dimensional image for simplicity, the techniques described here apply equally to three-dimensional images. The raw patient image 920 can further be manipulated through digital image processing before, during or after transmission through the medical services network.

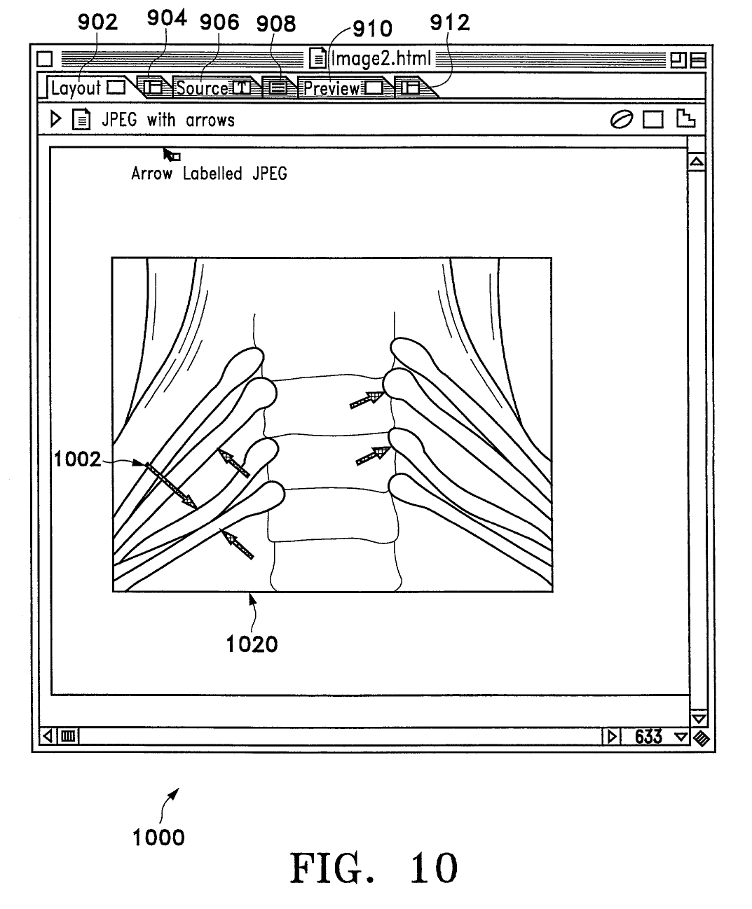

In FIG. 10, a user who is “composing” the image—such as a reading physician radiologist—will mark structures of anatomical and clinical interest. These markings are shown in this figure by yellow arrows 1002. Additional arrows may be provided on a routine basis by specialist technicians supervised by a physician. The arrows 1002 are preferably introduced as overlays over the image or become a part of the image, and the image is then mounted in an HTML or other similar language “jacket.”

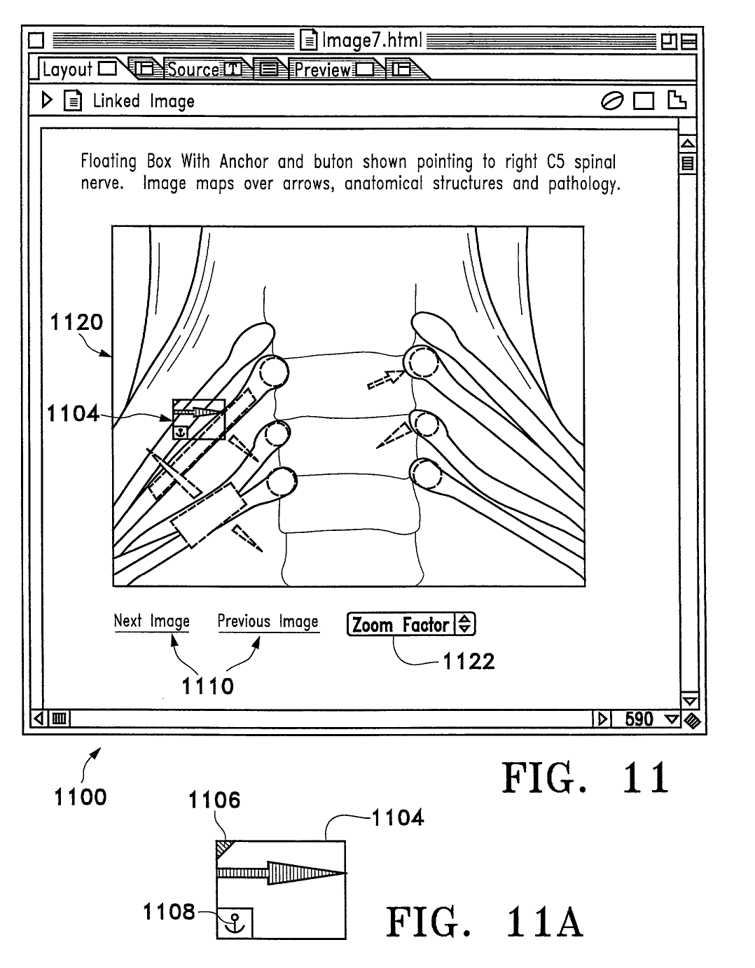

In FIG. 11, the next step in the image composition process is illustrated. Here, by means of the original layout or composition software mentioned above in the discussion of FIG. 9 or by using a different software package, HTML image maps 1102 are placed on the image, preferably as overlays. The composing user such as the reading physician or technician uses the composition software or an automated software programming method, which perhaps might be keyed to focus on certain colors, shapes, or other distinguishing marks or images on either the raw image 920 or the edited image 1020 from FIG. 10.

Still referring to FIG. 11, these HTML image maps 1102 are placed over the relevant anatomical structures and pathologic findings, as well as over the arrows 1002. In addition, the image may be provided with an HTML “floating box” 1104, seen here as a square holding a red arrow. Floating boxes may be interactively repositioned over an image by interaction through a browser such as Netscape Navigator or Internet Explorer. The small green triangle 1106 in the upper left corner of the box 1104 indicates that the arrow is actually in a “button field” which may also be used by “mouse over,” “mouse click”, or “mouse exit” to cause various type of information or other images to appear. Also included in the box 1104 is an HTML “anchor” 1108 which allows other locations in the viewing system to link to this floating box. At the bottom of the page are links 1110 to assist in navigating through a group of images. There may optionally be small “thumbnail versions” of the other images provided adjacent to the hyperlinked/annotated image 1120 of FIG. 11 for navigation. In addition, there is a pop-up list (marked “zoom factor”) 1122 which can be used to adjust the relative enlargement of the overall image or optionally in selected regions of the image.

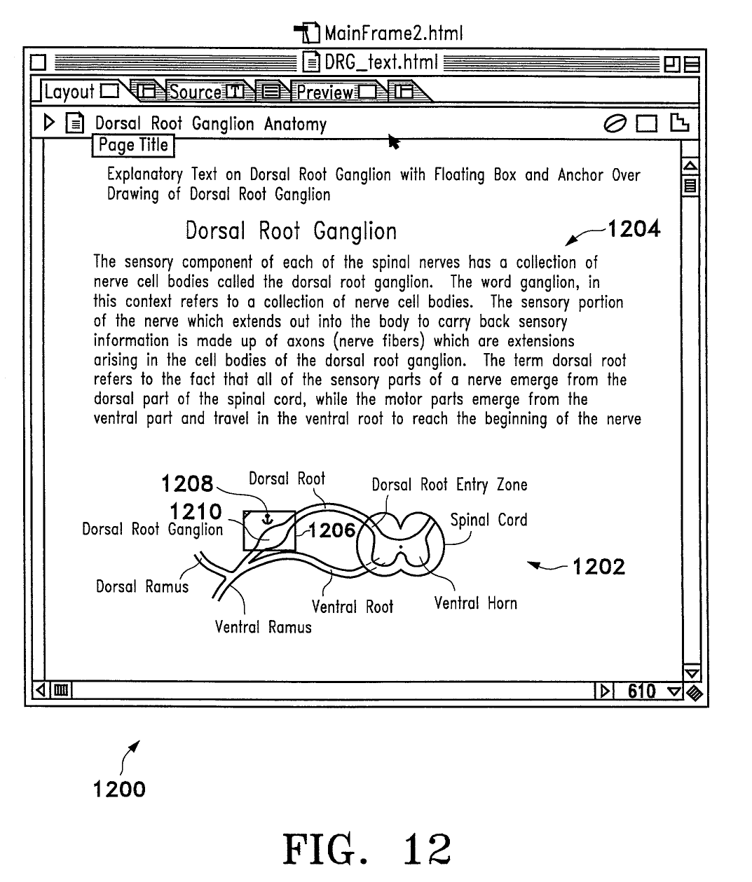

FIG. 12 illustrated the composition of an informational sheet 1200, which in this example is used to explain a particular aspect of the human anatomy. These informational sheets will include diagram sections 1202 and text sections 1204. Individual portions of the diagrams 1202 can be preferably accessed and referred back to the image through floating box 1206 and HTML anchor 1208 as depicted over the “Dorsal Root Ganglion” 1210. Alternate versions of such anatomical explanatory material can be provided for various classes of users (e.g., general, advanced, primary doctor, or specialist doctor).

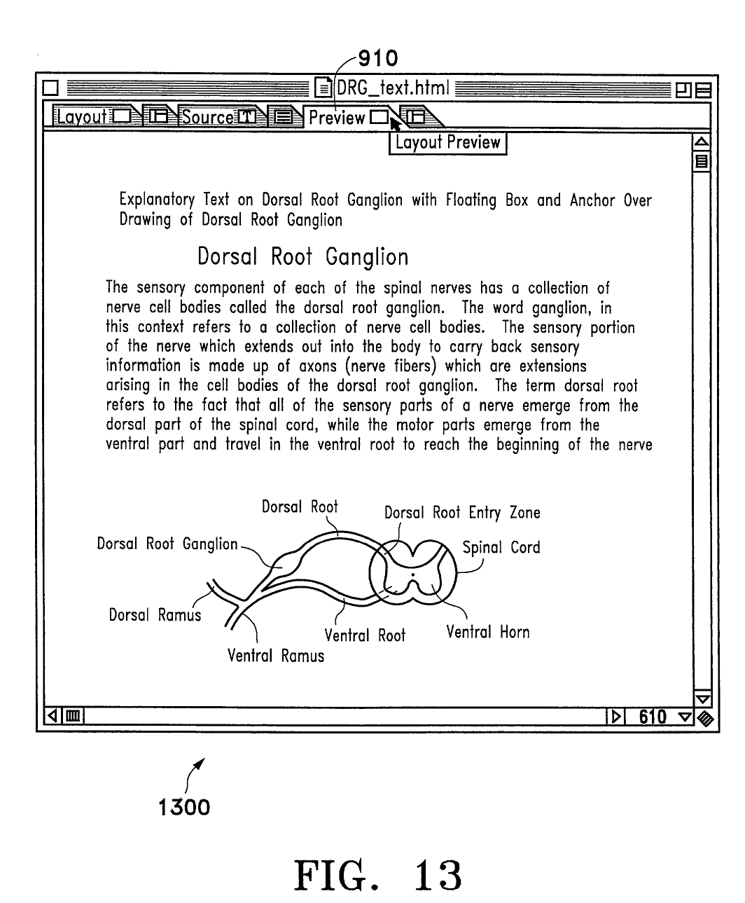

Using the “Preview tab 910, as shown in FIG. 13, a “Preview” screen 1300 of the actual appearance of one of the anatomy pages or another page being composed can be viewed. Upon selection or reference from another part of the viewer, highlighting can appear to direct the user the relevant portions of the text and drawing. Similarly, within the page, selection of some portion of description of the text can highlight portions of the drawing and vice versa.

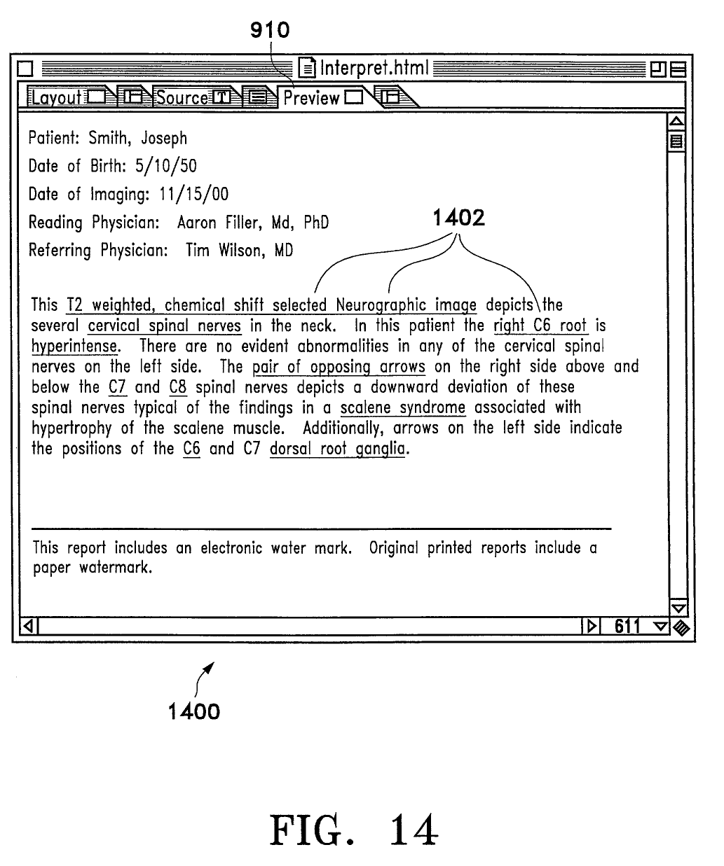

FIG. 14 illustrates in “Preview” mode a textual and hyperlinked physician interpretation of an image in which aspects of the imaging techniques, anatomy, and pathology may be discussed. Links 1402 are provided to explanatory text about anatomy, about pathology, and about the actual patient image being discussed. The links 1402 are shown in this figure as underlined and colored blue.

Many options can be used in the selection of text or images in any of these illustrated screen shots. For example, a user can click on text in the interpretation or in the anatomy descriptions or in the syndrome information, for example, and can then be directed back to particular locations on the image or taken to another textual description of the selected word, or taken to another portion of the live medical record. Selections through clicking or even just by passing a cursor over the particular selectable link can make regions light up or can drive the floating box, trigger animations, cause new windows to open showing additional data, or any other dynamic or static HTML action.

For security and authenticity purposes, electronic watermarks are preferably provided which allow verification of page authenticity through checksums or other security measures. Printed versions of the text may also include a printable watermark that is destroyed if the text on the page is manipulated.

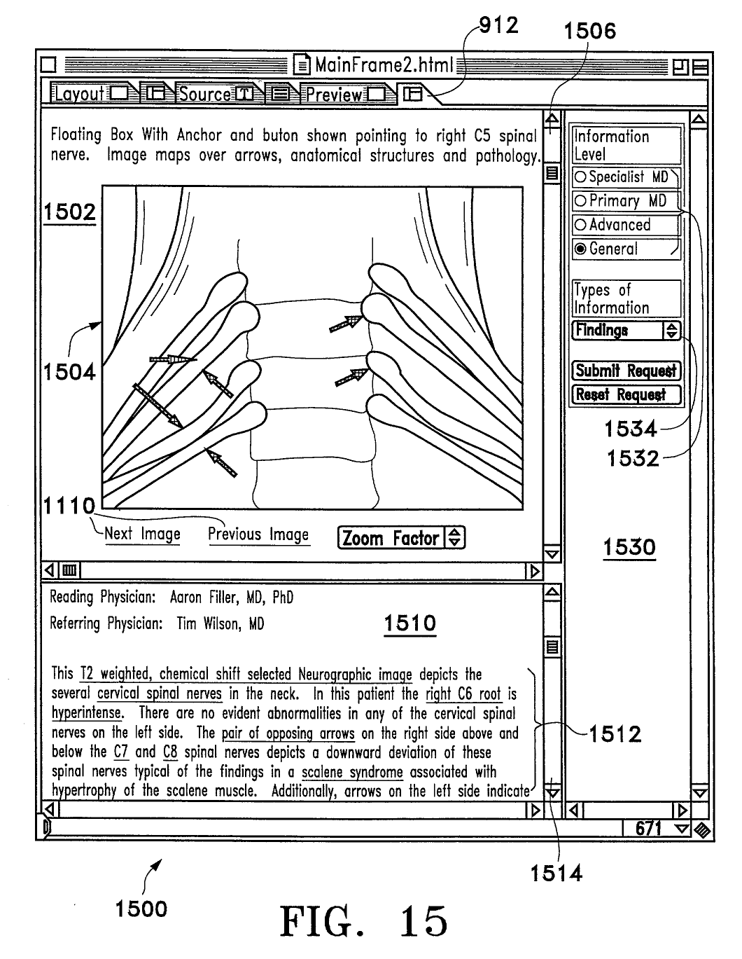

FIG. 15 provides a composite screen 1500 selected by the second composite image tab 912. An upper frame 1502 shows a hyperlinked and annotated patient image 1504, which shows the originally-described yellow arrows 1002 and a red arrow 1502 in the floating box 1104. Also included in this navigational view, as contrasted to the previous exemplary composition views, are navigational and viewing controls in the HTML frame 1502. For example, navigation key links 1110 (e.g., “Next Image” and “Previous Image”) are provided, as is a scroll bar 1506. A lower frame 1510 is provided with hyperlinked textual description 1512 associated with the upper frame image 1504. In this example, the lower frame textual message 1512 is a memorandum from the reading physician to the referring physician. These types of memoranda can help assist the referring physician to understand the diagnostic images provided by the diagnostic image source, as well as any diagnoses provided by the reading physician. Also described could be clinical decisions which would have to be made by the patient with the referring physician's assistance. Again, standard or novel frame navigation methods can be employed in the lower frame 1510, such as the illustrated scroll bar 1514.

Still referring to FIG. 15, the rightmost frame 1530 in this figure is a control form. By this control form, the viewer or user can select the desired information level (e.g., general, advanced, primary MD, or specialist MD), preferably through the illustrated radio buttons 1532. Further exemplary choices shown here as available to the user are the type of information desired, such as image interpretation, anatomical explanation, reference to syndromes producing certain types of pathology, or treatments and surgeries. This type of information is selectable through the shown web navigation feature 1534.

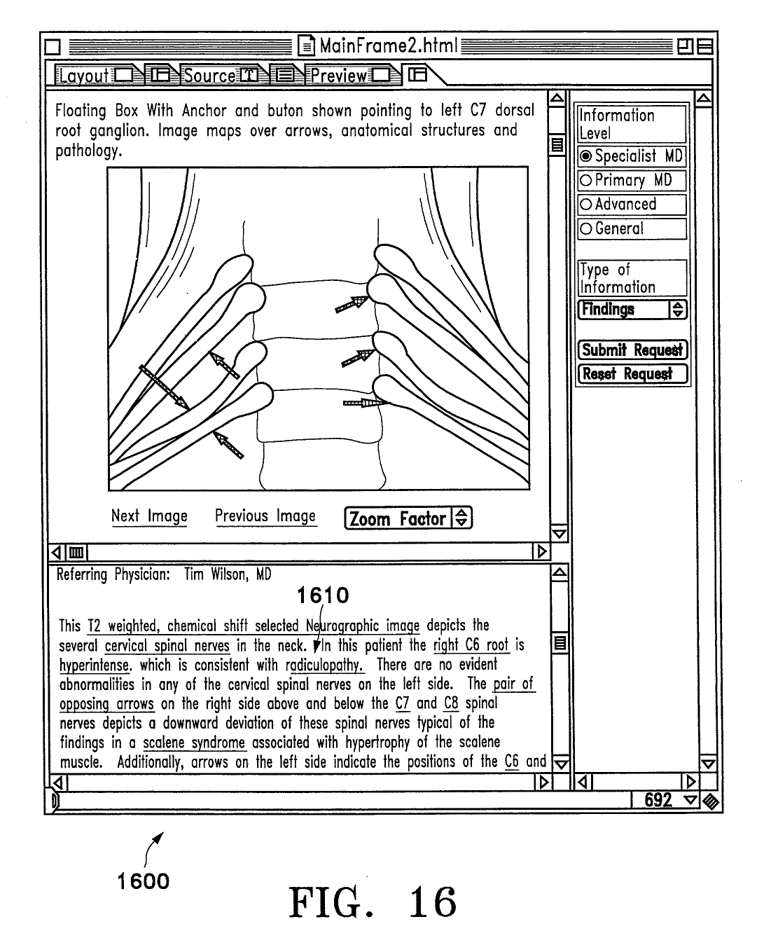

The view of FIG. 16 differs from that of FIG. 15 in that the red arrow has been moved by the user to indicate the left C8 ganglion. A pointer is positioned over the text referring to the right C8 spinal nerve and upon clicking, the red arrow will move to that structure.

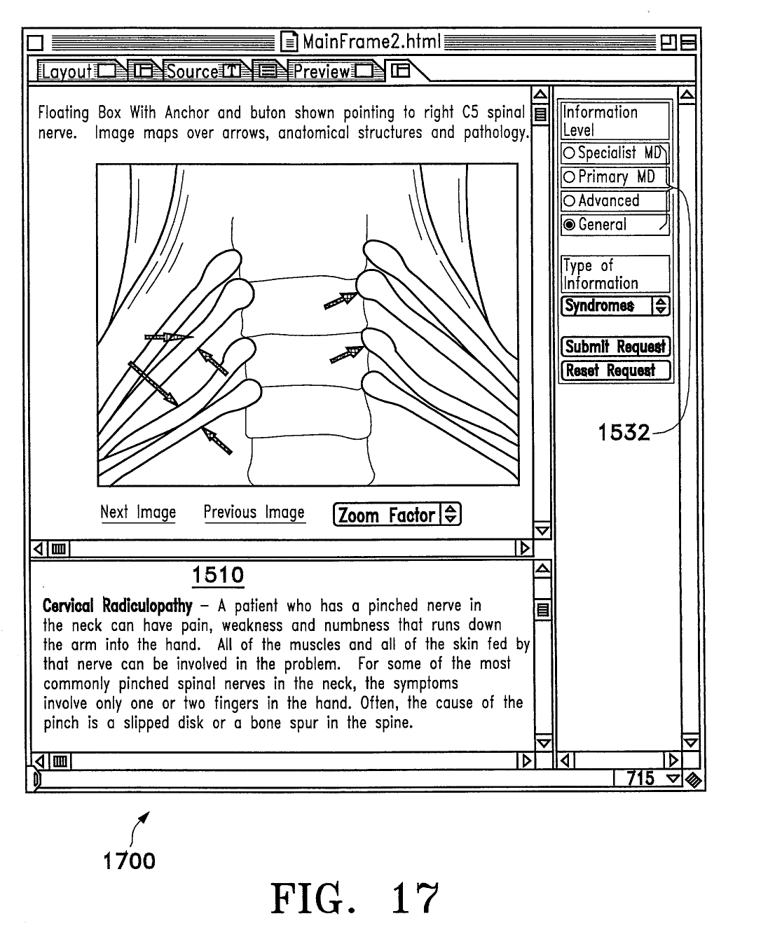

In FIG. 17, the user has used the radio buttons 1532 to select the “General” level of information and has used the feature 1534 to select “Syndrome” as the type of information desired. Also, from the lower frame 1510 of the prior figures, the user has clicked on the “radiculopathy” hyperlink 1610 in the interpretation. Upon this selection by the user, appropriate explanatory text replaces the prior interpretation text temporarily or fixedly in the lower frame 1510.

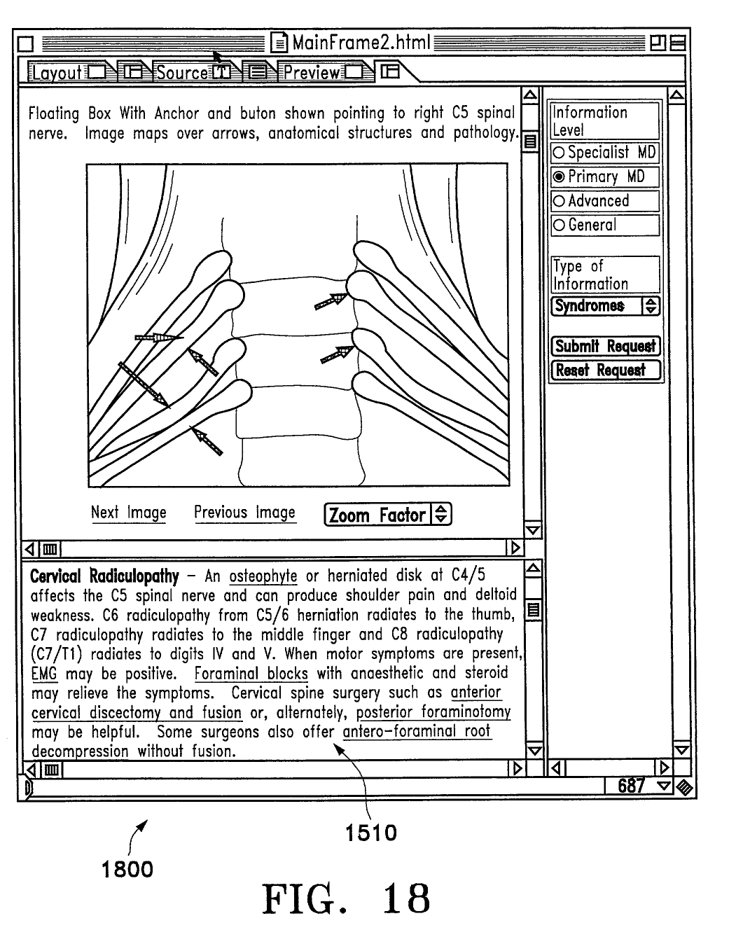

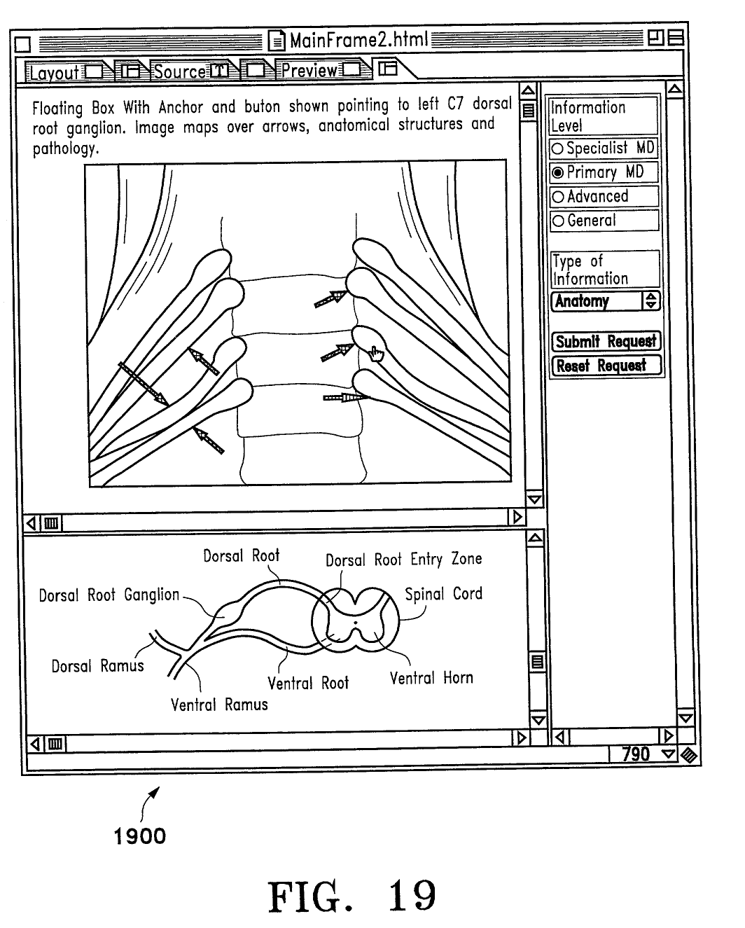

In FIG. 18, the user has switched to the “primary MD” level of information before clicking on “radiculopathy” 1610, which provides a more technical explanation of the medical term. This more technical explanation shown in the lower frame 1510 also preferably includes links to information about the various types of surgical treatments available.

The FIG. 19 screen shot differs from the screen shot of FIG. 18 in that the user has placed a pointer over a dorsal root ganglion in the image having first selected “Anatomy” as the type of information through feature 1524 and “Primary MD” as the information level through radio buttons 1522. The dorsal root ganglion diagram then temporarily replaces the textual interpretation in the lower frame 1510. A means to return to the interpretation is provided, preferably through a link and button (not shown), at the bottom of this scrolling field in the lower frame 1510.

One or more of the above screen shots may also provide links or pull-down menus for broadly-applicable functions such as an internal word search capability, a site map, user help information, or other similar, broadly useful function.

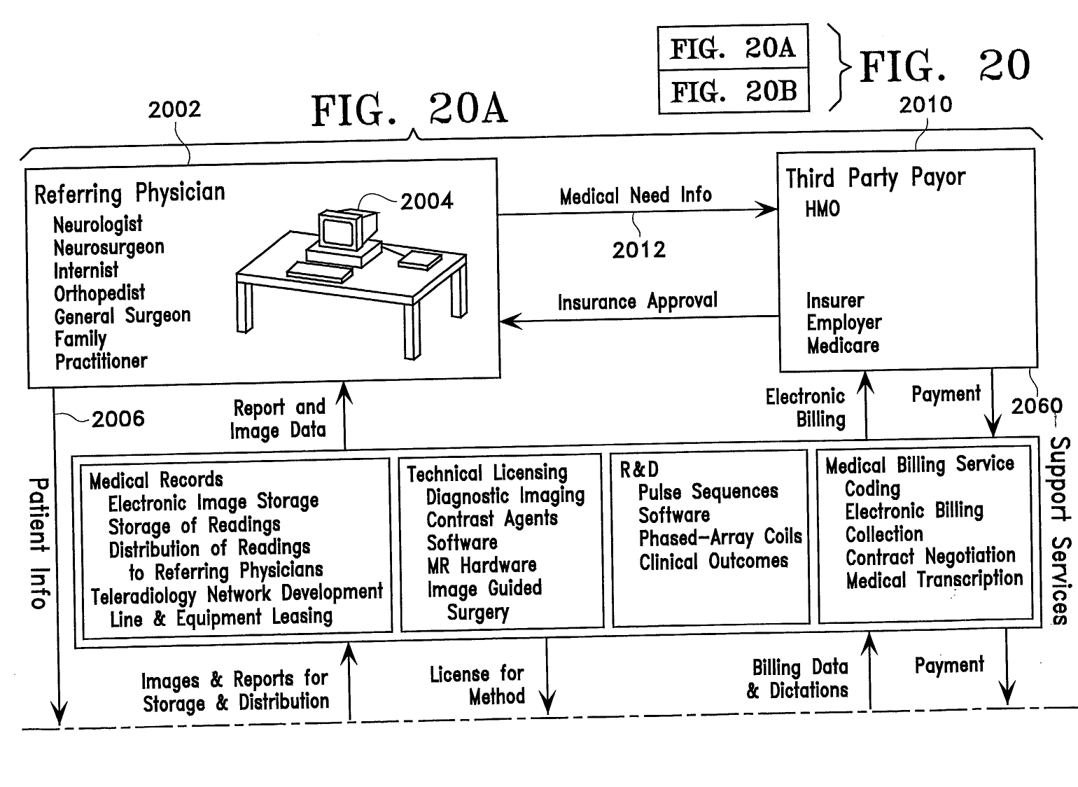

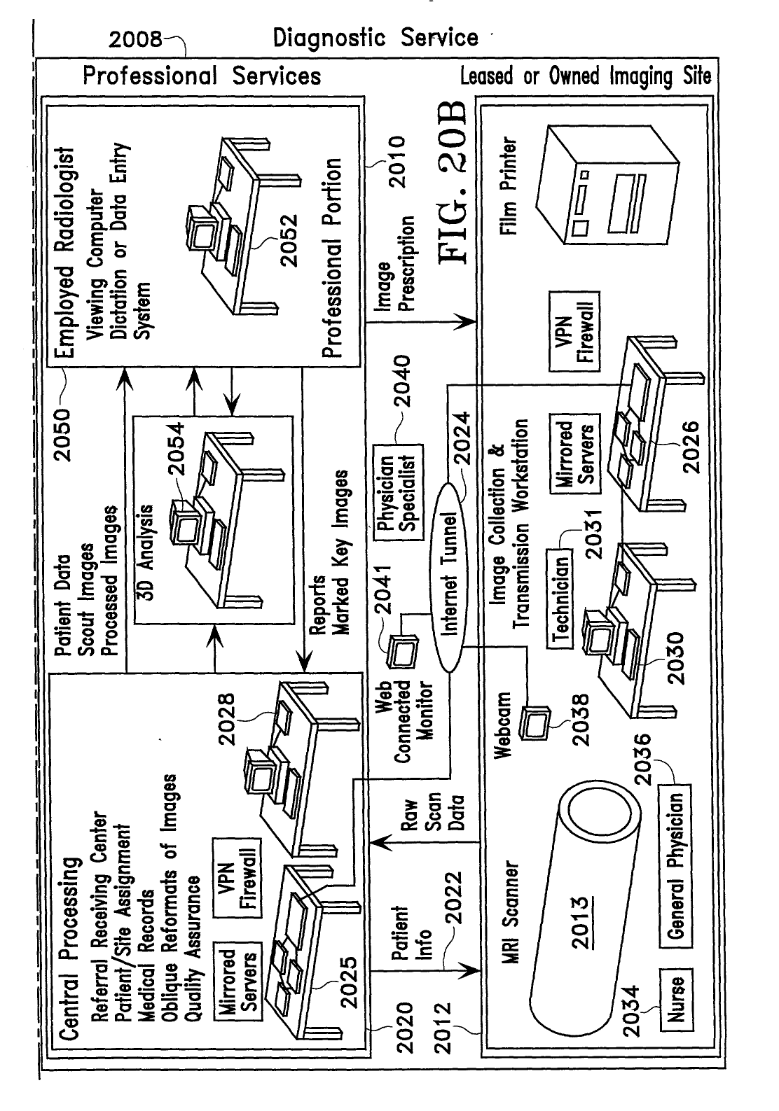

FIG. 20 is a block diagram illustrating a new process using the embodiments described in this application. Through this process, patient medical conditions can be diagnosed and live medical records can be created to facilitate the evaluation and treatment of patients. Treatment of a patient begins at the referring physician 2002. The referring physician would have a network-connected computer 2004, through which the referring physician would preferably provide patient information via information path 2006 to a diagnostic service source 2008, and also to a third-party payor 2010 through information path 2012. The referring physician might be a neurologist, neurosurgeon, internist, orthopedist, general surgeon, family practitioner, or other physician. The third-party payor can be an insurer, employer, Medicare, or other third-party payor.

The information provided by the referring physician would be primarily textual, although the referring physician could also provide image and/or sound data as a part of the patient record. This information would be provided from the referring physician 2002 through a network-connected computer 2004 at the physician's office. This information would include information about the patient and the presentation of the patient symptoms which prompted the referral to the diagnostic service source 2008. In this embodiment, the diagnostic service source 2008 contains two major sub-blocks the professional services area 2010 and the imaging area 2012. The sub-blocks—may be co-located or separate, and they may be owned by the same entity or different entities.

The primary task within the professional services area 2010 of the diagnostic service source 2008 is the analysis, marking, and composition of live medical records incorporating the digital patient images. The primary task of the imaging area 2012 is image collection and transmission of images back to the professional services area 2010. Ultimately, the professional services area 2010 would build a live medical record from the patient information provided by the referring physician 2002 along with an annotated and hyperlinked analyses of the patient's condition.

Still referring to FIG. 20, once the professional services area 2010 receives the referral from the referring physician 2002, patient intake is performed, further information is gathered, and the patient is assigned, if appropriate, to an imaging area 2012. The patient information is in turn transferred from a central processing area 2020 within the professional services area 2010 to the imagining area 2012 over link 2022. An appointment is then set up for the patient to visit the imaging area 2012. Various patient imaging approaches can be used at the imaging area 2012, such as MRI, CAT, digitized x-ray, motion fluoroscopy, angiogram, ultrasound, and nuclear medicine images. The imaging area could alternatively be another type of measuring area for patient conditions, such as for example, an area for taking electroencephalograms (EEG). The common denominator is that patient measurements are taken for incorporation into the patients medical records and that these measurements are amenable to display, annotation, and hyperlinking in those medical records whereby such measurements or images can be brought up again by the referring or reading physician and further annotated or displayed.

Preferably an internet tunnel 2024 is set up between the professional services area 2010 and the imaging area 2012. Through this internet tunnel 2024, a set of mirrored servers 2025, 2026 can be established in each of the two respective areas 2010, 2012. The use of mirrored servers allows central processing area 2010 to maintain an independent set of live patient records and thereby quickly make available such patient records for easy editing without requiring re-transmission of such records any time they needed to be edited. Thus, any changes occurring in the patient record at either location would show up at the other location. Terminals 2028, 2030 are provided at the two areas respectively. Terminal 2030 is preferably provided as an image collection and transmission workstation, which would typically be operated by a technician such as a radiology technician 2031.

In one embodiment, a webcam 2038 at the imaging area 2012 is connected to the internet tunnel 2024. The imaging process is sometimes quite difficult and requires the experienced guidance of the physician specialist 2040, who will be interpreting the images to help properly set-up the imaging equipment 2013 and properly position the patient. Thus, preferably the webcam 2038 provides a live image to a web-connected monitor 2041. The web-connected monitor could be at the professional services area 2010, or anywhere else having a relatively high-speed web connection. Through the web-connected monitor 2041, a physician specialist 2040, especially if such specialist had access to real-time monitoring of images being generated by the imaging equipment 2013, will preferably be able to assist the imaging staff 2031, 2034, and 2036 to set up the imaging equipment 2013 and patient to get the desired images.

The patient images are provided through the internet tunnel 2024 to the mirrored servers 2025, 2026. Preferably, the mirrored servers are synchronized through the internet tunnel 2024, whereby any changes made on one server is reflected on the other. Processing of the raw image data is then provided in the central processing area 2020 of the professional services area 2010. Here, 2D oblique reformats of the raw 3D images may be provided, and a technician can monitor the images for quality assurance. A radiologist 2050 is employed in the diagnostic service source 2008 for reviewing the computer images and marking and annotating with a computer 2052 portions of the images which are of particular interest, thereby tying specialized markings and annotations to the patient images for use in this web-based patient diagnostic system.

Raw and annotated images can be iteratively exchanged between the central processing area 2020 and the radiologist or other specialist 2050. Between those two boxes 2020, 2050 at the professional services area 2010 is also provided another workstation 2054 for 3D analysis. Preferably, a technician is employed to perform further annotation, marking, and other formatting of the digital images to be used in the live medical records. Thus, at the professional services area 2010, a number of professionals are employed, all under the supervision of a physician at that site for annotating and linking the relevant portions of the live medical record as was described in the previous sections of this document relating to the composition of live medical records.

Still referring to FIG. 20, another area is provided between the diagnostic services source 2008 on one hand, and the referring physician 2002 and the third-party payor 2010 on the other hand. This area is referred to as the support services area 2060. As shown in the figure, the support services area 2060 receives images and reports for storage and distribution from the diagnostic services source 2008. From here, these live patient records can be stored in medical records storage. One purpose of this support services area 2060 is to provide to the referring physician with reports which can be used to consult with and counsel the patient. Thus, such reports can be provided to the referring physician's computer 2004 through the support services area.

Other blocks in the support services area 2060 include a technical licensing block, which passes on the appropriate set of licensing rights to the diagnostic service source 2008. Another block is the R&D block, which monitors and maintains clinical outcomes. A Medical Billing Service block is provided which provides the pertinent functionality for passing on images to the third-party payor, along with other functions which may have been set earlier on between the entities.

Referring now generally to the implementation of the above-described embodiments, many alternative approaches can be employed to achieve these embodiments. For example, selection devices for manipulating the cursor and other screen images or HTML objects can include a mouse, trackball, touch screen, sterile touch screen the gloved surgeon can touch, light pointer, or optical or ultrasonic three-dimensional pointing system for use in surgeries or in other contexts. Further types of input devices might include voice recognition, including voice dictation software, and retinal position sensing. Also, beyond allowing a reading physician to direct patient imaging procedures by watching such procedures remotely through webcams and Internet-connected monitors, the embodiments described above can be used to help guide surgical exploration during operations or to help guide and drive robotic surgery devices. Specifically, the online camera monitoring aspects can be provided with the hyperlinked functions superimposed on images to facilitate image-guided operations, whether such operations are directly at the control of the surgeon or through robotic surgery devices.

An embodiment of the present invention may be written using JAVA, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other.

Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework.

The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved.

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data. Companies today are looking at using a private virtual network for both extranet and wide-area intranet.

Using a virtual private network involves encrypting data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPTP) and Microsoft has extended Windows NT to support it. VPN software is typically installed as part of a company's firewall server.

DICOM (Digital Imaging and Communications in Medicine) is an application layer network protocol for the transmission of medical images, waveforms, and ancillary information. It was originally developed by the National Electrical Manufacturers Association (NEMA) and the American College of Radiology for CAT and MRI scan images. It is now controlled by the DICOM Standards Committee, and supports a wide range of medical images across the fields of radiology, cardiology, pathology and dentistry. DICOM uses TCP/IP as the lower-layer transport protocol.

Transmission Control Protocol/Internet Protocol (TCP/IP) is the basic communication language or protocol of the Internet. It can also be used as a communications protocol in a private network (either an intranet or an extranet). When you are set up with direct access to the Internet, your computer is provided with a copy of the TCP/IP program just as every other computer that you may send messages to or get information from also has a copy of TCP/IP.

TCP/IP is a two-layer program. The higher layer, Transmission Control Protocol, manages the assembling of a message or file into smaller packets that are transmitted over the Internet and received by a TCP layer that reassembles the packets into the original message. The lower layer, Internet Protocol, handles the address part of each packet so that it gets to the right destination. Each gateway computer on the network checks this address to see where to forward the message. Even though some packets from the same message are routed differently than others, they'll be reassembled at the destination.

TCP/IP uses the client server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.)

Many Internet users are familiar with the even higher layer application protocols that use TCP/IP to get to the Internet. These include the World Wide Web's Hypertext Transfer Protocol (HTTP), the File Transfer Protocol (FTP), Telnet (Telnet) which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol (PPP). These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange. Other related Novell NetWare protocols are: the Routing Information Protocol (RIP), the Service Advertising Protocol (SAP), and the NetWare Link Services Protocol (NLSP).

Hypertext Markup Language (HTML) is the set of markup symbols or codes inserted in a file intended for display on a World Wide Web browser page. The markup tells the Web browser how to display a Web page's words and images for the user. Each individual markup code is referred to as an element (but many people also refer to it as a tag). Some elements come in pairs that indicate when some display effect is to begin and when it is to end.

HTML is a formal Recommendation by the World Wide Web Consortium (W3C) and is generally adhered to by the major browsers, Microsoft's Internet Explorer and Netscape's Navigator, which also provide some additional non-standard codes. The current version of HTML is HTML 4.0. However, both Internet Explorer and Netscape implement some features differently and provide non-standard extensions. Web developers using the more advanced features of HTML 4 may have to design pages for both browsers and send out the appropriate version to a user. Significant features in HTML 4 are sometimes described in general as dynamic HTML. What is sometimes referred to as HTML 5 is an extensible form of HTML called Extensible Hypertext Markup Language (XHTML).

Extensible Markup Language (XML) is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

XML, a formal recommendation from the World Wide Web Consortium (W3C), is similar to the language of today's Web pages, the Hypertext Markup Language (HTML). Both XML and HTML contain markup symbols to describe the contents of a page or file. HTML, however, describes the content of a Web page (mainly text and graphic images) only in terms of how it is to be displayed and interacted with. For example, a <P> starts a new paragraph. XML describes the content in terms of what data is being described. For example, a <PHONENUM> could indicate that the data that followed it was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed.

XML is “extensible” because, unlike HTML, the markup symbols are unlimited and self-defining. XML is actually a simpler and easier-to-use subset of the Standard Generalized Markup Language (SGML), the standard for how to create a document structure. It is expected that HTML and XML will be used together in many Web applications. XML markup, for example, may appear within an HTML page.

Early applications of XML include Microsoft's Channel Definition Format (CDF), which describes a channel, a portion of a Web site that has been downloaded to your hard disk and is then is updated periodically as information changes. A specific CDF file contains data that specifies an initial Web page and how frequently it is updated. Another early application is ChartWare, which uses XML as a way to describe medical charts so that they can be shared by doctors. Applications related to banking, ecommerce ordering, personal preference profiles, purchase orders, litigation documents, part lists, and many others are anticipated.

A JPEG is a graphic image created by choosing from a range of compression qualities (actually, from one of a suite of compression algorithm). When you create a JPEG or convert an image from another format to a JPEG, you are asked to specify the quality of image you want. Since the highest quality results in the largest file, you can make a trade-off between image quality and file size. Formally, the JPEG file format is ISO standard 10918. The JPEG scheme includes 29 distinct coding processes although a JPEG implementor may not use them all. JPEG is an acronym for Joint Photographic Experts Group, the committee that established the baseline algorithms.

Together with the Graphic Interchange Format (GIF) and Portable Network Graphics (PNG) file formats, the JPEG is one of the image file formats supported on the World Wide Web, usually with the file suffix of “.jpg”. You can create a progressive JPEG that is similar to an interlaced GIF.

Health Level Seven (HL/7) is one of several ANSI-accredited Standards Developing Organizations (SDOs) operating in the healthcare arena. Most SDOs produce standards (sometimes called specifications or protocols) for a particular healthcare domain such as pharmacy, medical devices, imaging or insurance (claims processing) transactions. Health Level Seven's domain is clinical and administrative data. Our mission is to: “To provide standards for the exchange, management and integration of data that support clinical patient care and the management, delivery and evaluation of healthcare services. Specifically, to create flexible, cost effective approaches, standards, guidelines, methodologies, and related services for interoperability between healthcare information systems.”

“Level Seven” refers to the highest level of the International Standards Organization's (ISO) communications model for Open Systems Interconnection (OSI) the application level. The application level addresses definition of the data to be exchanged, the timing of the interchange, and the communication of certain errors to the application. The seventh level supports such functions as security checks, participant identification, availability checks, exchange mechanism negotiations and, most importantly, data exchange structuring.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for managing a medical services network, comprising:
(a) receiving diagnostic data about a patient from a diagnostic service source, wherein the diagnostic data is obtained by performing a diagnostic service on the patient;
(b) sending the diagnostic data to an interpreter, wherein the interpreter interprets the diagnostic data to generate an interpretation of the diagnostic data;
(c) receiving the interpretation from the interpreter; and
(d) transmitting via a network at least one of the interpretation and the diagnostic data to a display.

2. The method of claim 1, wherein the diagnostic data is received from the diagnostic service source utilizing the network.

3. The method of claim 1, wherein the diagnostic data is sent to the interpreter utilizing the network.

4. The method of claim 1, wherein the interpretation is received from the interpreter utilizing the network.

5. The method of claim 1, wherein the interpreter is a reading physician.

6. The method of claim 1, wherein the diagnostic service performed on the patient involves magnetic resonance imaging, and wherein the diagnostic data comprises imaging data obtained from the magnetic resonance imaging of the diagnostic service.

7. The method of claim 1, wherein the diagnostic data includes video data captured by a video camera during performance of the diagnostic service.

8. The method of claim 1, wherein the interpretation includes at least one of: a diagnosis based on the diagnostic data, annotations, selectable links to additional information relating the diagnostic data.

9. The method of claim 1, further comprising utilizing the network to provide real-time monitoring and support to the diagnostic service sou performance of the diagnostic service.

10. The method of claim 1, further comprising storing the diagnostic data and the interpretation in a database.

11. The method of claim 1, further comprising generating billing codes and related documentation, and transmitting the generated billing codes and related documentation to an insurer.

12. The method of claim 1, further comprising processing the diagnostic data prior to sending the diagnostic data to the interpreter.

13. The method of claim 1, wherein transmitting via the network at least one of the interpretation and the diagnostic data to the display further comprises: receiving a request for at least one of the interpretation and the diagnostic data from a viewer utilizing the network; requiring the viewer to select a reading category, wherein each reading category has a set of links to additional information associated therewith; and displaying the interpretation and/or diagnostic data with the links associated with the selected reading category to the viewer via the network.

14. The method of claim 1, further comprising encrypting at least one of the interpretation and the diagnostic data prior to transmission to the display.

15. The method of claim 1, further comprising facilitating the scheduling of the diagnostic service.

16. The method of claim 15, wherein facilitating the scheduling of the diagnostic service comprises: receiving a request for a diagnostic service for a patient from a health care provider; notifying the diagnostic service source of the patient assignment utilizing the network; and instructing the patient to contact the diagnostic service source to schedule an appointment for performing the diagnostic service.

17. The method of claim 16, further comprising enabling the patient to contact the diagnostic service source via the network in order to schedule the appointment for performing the diagnostic service.

18. The method of claim 16, further comprising utilizing the network to direct advertising information to at least one of the health care provider and the patient.

19. The method of claim 16, firther comprising notifying an insurer of the patient about the diagnostic service utilizing the network.

20. The method of claim 16, further comprising storing information relating to the patient assignment in a database.

21. The method of claim 20, further comprising permitting at least one of the health care provider, the patient, and the diagnostic service source to access the information stored in the database utilizing the network.

22. The method of claim 16, further comprising obtaining information relating to the patient utilizing the network after receipt of the request for the diagnostic service, and storing the obtained information relating to the patient in a database.

23. A system for managing a medical services network, comprising:
(a) logic that receives diagnostic data about a patient from a diagnostic service source, wherein the diagnostic data is obtained by performing a diagnostic service on the patient;
(b) logic that sends the diagnostic data to an interpreter, wherein the interpreter interprets the processed diagnostic data to generate an interpretation of the diagnostic data;
(c) logic that receives the interpretation from the interpreter; and
(d) logic that transmits via a network at least one of the interpretation and the diagnostic data to a display.

24. The system of claim 23, wherein the diagnostic data is received from the diagnostic service source utilizing the network.

25. The system of claim 23, wherein the diagnostic data is sent to the interpreter utilizing the network.

26. The system of claim 23, wherein the interpretation is received from the interpreter utilizing the network.

27. The system of claim 23, wherein the network is capable of communication utilizing TCP/IP and IPX protocols.

28. The system of claim 23, wherein the diagnostic service performed on the patient involves magnetic resonance imaging, and wherein the diagnostic data comprises imaging data obtained from the magnetic resonance imaging from the diagnostic service.

29. The system of claim 23, wherein the diagnostic data includes video data captured by a video camera during performance of the diagnostic service.

30. The system of claim 23, wherein the interpretation includes at least one of: a diagnosis based on the diagnostic data, annotations, and selectable links to additional information relating the diagnostic data.

31. The system of claim 23, further comprising logic that provides over the network real-time monitoring and support to the diagnostic service source relating to performance of the diagnostic service.

32. The system of claim 23, further comprising logic that stores the diagnostic data and the interpretation in a database.

33. The system of claim 23, further comprising logic that generates billing codes and related documentation, and logic that transmits the generated billing codes and related documentation to an insurer.

34. The system of claim 23, further comprising logic that processes the diagnostic data prior to sending the diagnostic data to the interpreter.

35. The system of claim 23, wherein the logic for transmitting via the network at least one of the interpretation and the diagnostic data to the display further comprises: logic that receives a request for at least one of the interpretation and the diagnostic data from a viewer utilizing the network; logic that requires the viewer to select a reading category, wherein each reading category has a set of links to additional information associated therewith; and logic that displays the interpretation and/or diagnostic data with the links associated with the selected reading category to the viewer via the network.

36. The system of claim 23, further comprising logic that encrypts at least one of the interpretation and the diagnostic data prior to transmission to the display.

37. The system of claim 23, further comprising logic that schedules performance of the diagnostic service.

38. The system of claim 37, wherein the scheduling logic comprises: logic that receives a request for a diagnostic service for a patient from a health care provider; logic that notifies the diagnostic service source of the patient assignment utilizing the network; and logic that instructs the patient to contact the diagnostic service source to schedule an appointment for performing the diagnostic service.

39. The system of claim 37, further comprising logic that enables the patient to contact the diagnostic service source via the network in order to schedule the appointment for performing the diagnostic service.

40. The system of claim 37, further comprising logic that uses the network to direct advertising information to at least one of the health care provider and the patient.

41. The system of claim 37, further comprising logic that notifies an insurer of the patient about the diagnostic service utilizing the network.

42. The system of claim 37, further comprising logic that stores information relating to the patient assignment in a database.

43. The system of claim 42, further comprising logic that permits at least one of the health care provider, the patient, and the diagnostic service source to access the information stored in the database utilizing the network.

44. The system of claim 37, further comprising logic that obtains information relating to the patient utilizing the network after receipt of the request for the diagnostic service, and logic that stores the obtained information relating to the patient in a database.

45. A computer program product for managing a medical services network, comprising:
(a) computer code for receiving diagnostic data about a patient from a diagnostic service source, wherein the diagnostic data is obtained by performing a diagnostic service on the patient;
(b) computer code for sending the diagnostic data to an interpreter, wherein the interpreter interprets the processed diagnostic data to generate an interpretation of the diagnostic data;
(c) computer code for receiving the interpretation from the interpreter; and
(d) computer code for transmitting via a network at least one of the interpretation and the diagnostic data to a display.

46. The computer program product of claim 45, wherein the diagnostic data is received from the diagnostic service source utilizing the network.

47. The computer program product of claim 45, wherein the interpretation is received from the interpreter utilizing the network.

48. The computer program product of claim 45, wherein the diagnostic service performed on the patient involves magnetic resonance imaging, and wherein the diagnostic data comprises imaging data obtained from the magnetic resonance imaging of the diagnostic service.

49. The computer program product of claim 45, wherein the diagnostic data includes video data captured by a video camera during performance of the diagnostic service.

50. The computer program product of claim 45, wherein the interpretation includes at least one of: a diagnosis based on the diagnostic data, annotations, selectable links to additional information relating the diagnostic data.

51. The computer program product of claim 45, further comprising computer code for storing the diagnostic data and the interpretation in a database.

52. The computer program product of claim 45, further comprising computer code for generating billing codes and related documentation, and computer code for transmitting the generated billing codes and related documentation to an insurer.

53. The computer program product of claim 45, further comprising computer code for processing the diagnostic data prior to sending the diagnostic data to the interpreter.

54. The computer program product of claim 45, wherein the computer code for transmitting via the network at least one of the interpretation and the diagnostic data to the display further comprises: computer code for receiving a request for at least one of the interpretation and the diagnostic data from a viewer utilizing the network; computer code for requiring the viewer to select a reading category, wherein each reading category has a set of links to additional information associated therewith; and computer code for displaying the interpretation and/or diagnostic data with the links associated with the selected reading category to the viewer via the network.

55. The computer program product of claim 45, further comprising computer code for encrypting at least one of the interpretation and the diagnostic data prior to transmission to the display.

56. The computer program product of claim 45, further comprising computer code for facilitating the scheduling performance of the diagnostic service.

57. The computer program product of claim 56, wherein the computer code for facilitating the scheduling performance of the diagnostic service comprises:
computer code for receiving a request for a diagnostic service for a patient from a health care provider; computer code for notifying the diagnostic service source of the patient assignment utilizing the network; and computer code for instructing the patient to contact the diagnostic service source to schedule an appointment for performing the diagnostic service.

58. The computer program product of claim 57, further comprising computer code for enabling the patient to contact the diagnostic service source via the network in order to schedule the appointment for performing the diagnostic service.

59. The computer program product of claim 57, further comprising computer code for utilizing the network to direct advertising information to at least one of the health care provider and the patient.

60. The computer program product of claim 57, further comprising computer code for notifying an insurer of the patient about the diagnostic service utilizing the network.

61. The computer program product of claim 57, further comprising computer code for storing information relating to the patient assignment in a database.

62. The computer program product of claim 6 1, further comprising computer code for permitting at least one of the health care provider, the patient, and the diagnostic service source to access the information stored in the database utilizing the network.

63. The computer program product of claim 57, further comprising computer code for obtaining information relating to the patient utilizing the network subsequent receipt of the request for the diagnostic service, and computer code for storing the obtained information relating to the patient in a database.

64. A computer-based patient medical record comprising:
(a) a digitally encoded patient image;
(b) at least one clickable image map placed over said patient image; and
(c) additional information linked to said clickable image map, whereby selection of said clickable image map by a user of said computer-based patient medical record retrieves said additional information.

65. The computer-based patient medical record of claim 64 wherein said computer-based patient medical record further comprises at least one graphical symbol superimposed on said digitally encoded patient image.

66. The computer-based patient medical record of claim 65 wherein said graphical symbol is stored digitally within said digitally encoded patient image.

67. The computer-based patient medical record of claim 65 wherein said graphical symbol is stored as an overlay in a separate file associated with said digitally encoded patient image.

68. The computer-based patient medical record of claim 64 wherein said additional information is stored in alternative sets and wherein data from one of said alternative sets is provided to said user according to the user's selection.

69. A computer-based user interface for accessing a computer-based medical record having a digitally encoded patient image, at least one clickable image map placed over said patient image, and additional information linked to said clickable image map, said computer-based user interface comprising:
(a) a computer screen for display of said computer-based medical record;
(b) a user input whereby a user can access said additional information linked to said clickable image map; and
(c) a control form whereby said user can select the format or content of said additional information which said user accesses through said link to said clickable image map.

70. The computer-based user interface of claim 69 wherein said user input is a computer mouse controlling a cursor's movement on said computer screen.

71. The computer-based user interface of claim 69 wherein said control form is a pop-up menu accessed by clicking on said clickable image map.

72. The computer-based user interface of claim 69 wherein said user input is selected from the group of input mechanisms consisting of: mouse; trackball; touch tablet; sterile touch tablet; light pointer; optical three dimensional pointing system; ultrasonic three dimensional pointing system; voice recognition; and retinal position sensing.

73. The computer-based user interface of claim 69 and further providing HTML actions initiated by passing selecting said clickable image map.

74. The computer-based user interface of claim 73 wherein said HTML actions are selected from the group consisting of: displaying additional information about the portion of the digitally encoded patient image associated with said clickable image map; highlighting said portion of the digitally encoded patient image associated with said clickable image map; driving a floating box associated with on-screen cursor; triggering animations; causing a new window to open on said computer screen; and bringing up a pop-up menu which presents further options to the user.

75. The computer-based user interface of claim 73 and further comprising HTML selection features for activating broadly-applicable functions.

76. The computer-based user interface of claim 75 wherein said broadly-applicable functions are selected from the group consisting of: an internal word-search capability; an external web-search capability; a live medical record site map; and user help information.

77. A method for gathering patient data comprising:
(a) providing patient measuring equipment;
(b) establishing a web-based camera focused in the proximity of said patient measuring equipment whereby the position of a patient is within said camera's field of view;
(c) establishing a web-based monitor positioned remotely from said patient measuring equipment and connected to said web-based camera through an web-based connection;
(d) establishing a communication path from said remotely positioned web-based monitor to the area in which the patient measuring equipment is located whereby a physician can direct the manner in which the patient measuring is being conducted.

78. The method of claim 77 wherein said patient measuring comprises patient imaging.

79. The method of claim 77 and further comprising a web-based communication link between the measuring equipment and the web-based monitor whereby said physician can further monitor the measurements being conducted.

80. A method of composing a computer-based patient medical record comprising:
(a) entering information about a patient in a database to create an initial computer-based patient record;
(b) associating web-based programming commands with at least portions of said initial computer-based patient record to create an enhanced computer-based patient record.

81. The method of claim 80 and further comprising the step of addition graphical patient information to said initial computer-based patient record and further associating web-based programming commands with at least portions of said graphical patient information.

82. The method of claim 81 wherein said graphical patient information is a diagnostic image of some aspect of the patient's anatomy.

83. The method of claim 82 wherein said web-based programming commands are hyperlinks associated with certain areas within said diagnostic image.

84. The method of claim 82 and further comprising the step of adding graphical images to said diagnostic image.

85. The method of claim 84 where said web-based programming commands are hyperlinks associated with said graphical images.

86. The method of claim 80 wherein a referring physician creates said initial computer-based patient record.

87. The method of claim 86 wherein a diagnostic imaging source provides a diagnostic image of some aspect of the patient's anatomy.

88. The method of claim 87 wherein a reading physician add said diagnostic image to said initial computer-based patient record and further adds graphical images to said diagnostic image.

89. The method of claim 88 wherein a technician adds web-based programming commands which are associated with said diagnostic image.

90. The method of claim 80 wherein said web-based programming commands are hyperlinks to said at least portions of said initial computer-based patient record and wherein said hyperlinks provide further information about the linked portions of said patient records.
